(19) United States
(12) Patent Application Publication
(10) Pub. No.: US 2024/0292842 A1
(43) Pub. Date: Sep. 5, 2024

(54) Compositions Containing Rare Earth Oxides and Precious Metals for Biological Contaminant Removal

(71) Applicant: Neo Chemicals & Oxides, LLC, Greenwood Village, CO (US)

(72) Inventors: Mason Reames HANELINE, Orange, CA (US); Steven Paul Williams, Sillamae (EE)

(73) Assignee: Neo Chemicals & Oxides, LLC, Greenwood Village, CO (US)

(21) Appl. No.: 18/593,214

(22) Filed: Mar. 1, 2024

Related U.S. Application Data
(60) Provisional application No. 63/449,242, filed on Mar. 1, 2023.

(51) Int. Cl. A01N 59/16; B01D 37/02

(52) U.S. Cl. CPC A01N 59/16; B01D 37/025; B01D 2257/91; B01D 2325/48

(57) ABSTRACT

An antimicrobial composition comprising about 99.95 wt % to about 50 wt % of a particulate oxide composition with precious metals dispersed on the surface of the particulate oxide composition. In this antimicrobial composition, the precious metals are selected from the group consisting of copper (Cu), nickel (Ni), silver (Ag), palladium (Pd), platinum (Pt), ruthenium (Ru), gold (Au), osmium (Os), rhodium (Rh), and mixtures thereof, and the particulate oxide composition comprises cerium oxide, trivalent dopant selected from the group consisting of yttrium (Y), lanthanum (La), neodymium (Nd), praseodymium (Pr), and mixtures thereof, and optionally an additional oxide selected from the group consisting of aluminum (Al), titanium (Ti), zirconium (Zr), hafnium (Hf), silicon (Si) and mixtures thereof, with the cerium oxide being present in an amount greater than the trivalent dopant. Also described are methods of using these compositions to remove biological contaminants.

### RELATED APPLICATION

This application claims priority to and benefit of U.S. Provisional Application No. 63/449,242 filed Mar. 1, 2023, the contents of which are hereby incorporated by reference in their entirety.

### FIELD OF THE INVENTION

This disclosure relates to an antimicrobial composition comprising a trivalent doped cerium oxide (CeO₂) particulate composition with precious metals dispersed on the surface. This disclosure also relates to the use of these compositions for biological contaminant removal, including as antimicrobial/antibacterial/antiviral agents. As such, these compositions have uses for removing bacteria, viruses, protozoa (e.g., amoebae), fungi (e.g., mold), algae, yeast, and the like. In particular, these compositions can be used in methods for treating fluids, including liquids or air, and solid surfaces through contact.

### INTRODUCTION

Various technologies have been used to remove biological contaminants from air and aqueous systems. Examples of such techniques include adsorption on high surface area materials, such as alumina, filters with pore sizes smaller than the biological contaminants, and the use of highly oxidative materials such as chlorine and bromine. Certain metals have also found use because they exhibit the oligodynamic effect which is the biocidal effect of metals. Metals known to exhibit the oligodynamic effect are Al, Sb, As, Ba, Si, B, Cu, Au, Pb, Hg, Ni, Ag, Th, Sn, and Zn. Incorporation of these into technologies for air or aqueous system treatment remains a challenge as the toxicity towards human and animal life and the cost are major concerns.

The need for effective and inexpensive antimicrobial materials to remove bacteria, viruses, and other microbial contaminants, from fluids, including air, water, and other aqueous systems, remains.

### SUMMARY

This disclosure generally relates to an antimicrobial composition comprising a particulate oxide composition with precious metals (PGMs) dispersed on the surface and the use of this composition for removing biological contaminants, including bacteria, viruses, and other microbial contaminants, through contact. The particulate oxide composition is a trivalent doped cerium oxide (CeO₂), which is described herein as a particulate oxide composition. As such, compositions disclosed herein can remove biological contaminants from air and aqueous liquid streams and can particularly remove bacteria and viruses from air and water whether the microbes are in high or very low concentrations.

The antimicrobial composition comprises about 99.95 wt % to about 50 wt % of a particulate oxide composition with precious metals dispersed on the surface of the particulate oxide composition. In certain embodiments, the precious metals are present in an amount of about 0.05 wt % to about 25 wt % based on the total weight of the antimicrobial composition. In this antimicrobial composition, the precious metals are selected from the group consisting of copper (Cu), nickel (Ni), silver (Ag), palladium (Pd), platinum (Pt), ruthenium (Ru), gold (Au), osmium (Os), rhodium (Rh), and mixtures thereof. The particulate oxide composition comprises cerium oxide, trivalent dopant selected from the group consisting of yttrium (Y), lanthanum (La), neodymium (Nd), praseodymium (Pr), and mixtures thereof, and optionally an additional oxide selected from the group consisting of aluminum (Al), titanium (Ti), zirconium (Zr), hafnium (Hf), silicon (Si) and mixtures thereof, with the cerium oxide being present in an amount greater than the trivalent dopant in the particulate oxide composition.

The particulate oxide composition has a unique depth profile in which the average trivalent dopant to Ce ratio at about 0 nm to about 3.5 nm from the surface of the particulate composition is greater than the trivalent dopant to Ce ratio at about 15 nm from the surface of the particulate composition.

In particular embodiments of the particulate oxide composition, the average trivalent dopant to Ce ratio at about 0 nm to about 3.5 nm from the surface of the particulate composition is about 10% to about 250% greater than the trivalent dopant to Ce ratio at about 15 nm from the surface of the particulate oxide composition. In other embodiments, the average trivalent dopant to Ce ratio at about 0 nm to about 3.5 nm from the surface of the particulate composition is about 15% to about 250% greater than the trivalent dopant to Ce ratio at about 15 nm from the surface of the particulate oxide composition.

In certain embodiments of the particulate oxide compositions, the particulate oxide comprises cerium oxide in an amount of about 99.95 wt % to about 20 wt % based on the total weight of the particulate oxide composition; trivalent dopant in an amount of about 0.1 wt % up to about 50 wt % based on the total weight of the particulate oxide composition; and additional oxide in an amount of about 70 wt % to about 0 wt % based on the total weight of the particulate oxide composition. In specific embodiments, there is about 0 wt % additional metal oxide.

The antimicrobial composition as disclosed herein comprises this particulate oxide composition with precious metals dispersed on the surface of the particulate oxide composition. The antimicrobial composition comprises the precious metals in an amount of about 0.1 wt % up to about 50 wt % based on the total weight of the composition. In certain embodiments, the antimicrobial composition comprises the precious metals in an amount of about 1 wt % to about 25 wt % based on the total weight of the composition. In other embodiments, the antimicrobial composition comprises the precious metals in an amount of about 1 wt % to about 10 wt % based on the total weight of the composition. As described, the precious metals are selected from the group consisting of copper (Cu), nickel (Ni), silver (Ag), palladium (Pd), platinum (Pt), ruthenium (Ru), gold (Au), osmium (Os), rhodium (Rh), and mixtures thereof. In certain embodiments, the precious metals are silver (Ag), palladium (Pd), platinum (Pt), ruthenium (Ru), or mixtures thereof.

In one specific embodiment, the precious metals are silver (Ag) and are in an amount of about 0.05 wt % to about 0.3 wt % based on the total weight of the antimicrobial composition. In another specific embodiment, the precious metals are ruthenium (Ru) and are in an amount of about 0.05 wt % to about 5 wt % based on the total weight of the antimicrobial composition.

These compositions, containing the particulate oxide composition with precious metals dispersed on the surface, have biological contaminant removal properties, and as such, have uses for removing bacteria or viruses from fluids, including air and water, and/or from surfaces. The biological contaminants to be removed include bacteria, viruses, protozoa (e.g., amoebae), fungi (e.g., mold or fungus), and the like.

Also disclosed herein are supported compositions comprising a support material and the antimicrobial compositions. The supported composition has biological contaminant removal properties, and as such, has uses for removing bacteria or viruses from fluids, including air and water, and/or from surfaces. The biological contaminants to be removed include bacteria, viruses, protozoa (e.g., amoebae), fungi (e.g., mold or fungus), and the like.

The supported compositions for removing biological contaminants as disclosed herein comprises a support material comprising an organic polymer, cotton, glass fiber, or mixtures thereof and the antimicrobial composition as described herein. In the supported compositions, the antimicrobial composition is deposited on or within the support material.

In specific embodiments, these supported compositions comprise about 0.5 to about 80 weight % antimicrobial composition based on the total weight of the supported composition.

The supported composition containing the support material and antimicrobial composition is in a rigid or elastic form and this supported composition can be made into an article for removing biological contaminants, such as a filter, a fixed bed filter system, a plastic or glass bottle or container, a plastic or glass touch surface, and the like.

In one embodiment, a plastic article is disclosed. This plastic article comprises: a supported composition for removing biological contaminants comprising (i) an organic polymer selected from the group consisting of polyethylene, polyvinyl chloride, nylon, polypropylene, polyester, polyurethane, polyamide, polyolefin, polycarbonate, copolymers thereof, and mixtures thereof; and (ii) the antimicrobial composition as described herein, wherein the antimicrobial composition is deposited on or within the organic polymer, and the plastic article comprises about 50 to about 100 weight percent of the supported composition. The plastic article can be a filter, a fixed bed filter system, a plastic bottle or container, a plastic touch surface, a plastic doorknob or handle cover, a plastic elevator button cover, and the like.

The antimicrobial compositions per se, the supported compositions, and the articles can be used in methods for removing biological contaminants. These biological contaminants include bacteria, viruses, protozoa (e.g., amoebae), fungi (e.g., mold or fungus), and the like.

In one embodiment the method for removing biological contaminants comprises: (i) providing the antimicrobial compositions disclosed herein; (ii) contacting the antimicrobial composition with a biological contaminant wherein the biological contaminant is selected from the group consisting of bacteria, viruses, fungi, protozoa (e.g., amoebae), and mixtures thereof; and (iii) removing at least about 90% of the biological contaminant through contact with the antimicrobial composition. In some embodiments, the antimicrobial composition is contained within a filter material or a plastic.

In certain embodiments the methods treat an aqueous stream and the biological contaminant is in the aqueous stream. In other embodiments, the methods treat a gaseous stream and the biological contaminant is in the gaseous stream. In yet other embodiments, the contacting is through touch of a solid to the antimicrobial composition and thus treat a solid surface through touch. In certain of these embodiments, the contacting is through touch of a solid to an article comprising the antimicrobial composition.

In specific embodiments of treating a fluid (i.e., a gaseous or aqueous stream), the methods may further comprise a step of setting a target concentration of biological contaminant. In these embodiments, a biological contaminant may be identified and a target concentration for that biological contaminant may be set. The methods additionally may comprise a step of monitoring the treated stream for the biological contaminant.

In a certain embodiment, these methods are for removing biological contaminants from fluid or are methods for treating a fluid. In these embodiments, the fluid may be a gaseous or aqueous stream. In these embodiments, the methods comprise (i) providing the antimicrobial composition disclosed herein; (ii) contacting a fluid containing biological contaminant with the antimicrobial composition, wherein the biological contaminant is selected from the group consisting of bacteria, viruses, fungi (e.g., mold), protozoa (e.g., amoebae), and mixtures thereof; and (iii) removing biological contaminant from the fluid through contact with the antimicrobial composition. The biological contaminant can be removed in an amount of 90% or more. When the fluid is a liquid, the antimicrobial composition may be used per se and the method may further comprise filtering the fluid/liquid.

In specific embodiments, these methods are for removing biological contaminants from fluid using a supported composition. In these embodiments, the fluid may be a gaseous or aqueous stream. In these embodiments, the methods comprise (i) providing a supported composition comprising (a) a support material comprising an organic polymer, cotton, glass fiber, or mixtures thereof and (b) the antimicrobial composition disclosed herein; (ii) contacting a fluid containing biological contaminant with the supported composition, wherein the biological contaminant is selected from the group consisting of bacteria, viruses, fungi (e.g., mold), protozoa (e.g., amoebae), and mixtures thereof; and (iii) removing biological contaminant from the fluid through contact with the supported composition. The biological contaminant can be removed in an amount of 90% or more.

These method of treating a fluid or a gaseous or aqueous stream using the antimicrobial composition per se or a supported composition may further comprise a step of setting a target concentration of biological contaminant. In these methods a biological contaminant of interest is identified and then a target concentration for that biological contaminant is set. The methods additionally may comprise a step of monitoring the biological contaminant in the treated stream. The monitoring may be done by sampling or may be continuous.

In methods of treating aqueous streams, the antimicrobial composition may be used per se by slurrying with the aqueous stream. These methods including slurrying may further comprise a step of filtering.

In specific embodiments, the methods comprise the steps of (i) providing a supported composition comprising (a) a support material comprising an organic polymer, cotton, glass fiber, or mixtures thereof and (b) the antimicrobial composition disclosed herein; (ii) setting a target concentration of a biological contaminant; (iii) contacting a gaseous or aqueous stream containing biological contaminant with the supported composition and removing biological contaminant through contact with the supported composition to provide a treated stream; and (iv) monitoring the treated stream for the biological contaminant, wherein the biological contaminant is selected from the group consisting of bacteria, viruses, fungi (e.g., mold), protozoa (e.g., amoebae), and mixtures thereof. The target concentration can be set at a certain amount of contaminant (e.g., virus, bacteria, protozoa/amoebae, or fungi) or can be set at the limit of detection. The monitoring may be done by sampling or may be continuous.

### BRIEF DESCRIPTION OF THE FIGURES

FIG. 1 is an SEM image of the composition of Example 1 with a scale bar of 200 nm.

FIG. 2 is an SEM image of the composition of Example 1 with a scale bar of 2 μm.

FIG. 3 is a TEM image of the composition of Example 1 with a scale bar of 10 nm. The light field image is on the left and the dark field image is on the right.

FIG. 4 is a TEM image of the composition of Example 1 with a scale bar of 20 nm. The light field image is on the left and the dark field image is on the right.

FIG. 5A is the temperature programed desorption of CO₂ for the composition of Example 1.

FIG. 5B is the temperature programed desorption of CO₂ for the composition of Example 2.

FIG. 5C is the temperature programed desorption of CO₂ for the composition of Example 3.

FIG. 6 is the temperature programed desorption of H₂ for the composition of Example 1, Example 2, and Example 3.

FIG. 7 is the zeta-potential vs pH graph for the composition of Example 1, Example 2, and Example 3.

FIG. 8 is a graph of the ratio of LaO⁺/CeO⁺ vs depth for the composition of Example 1 and the composition of Example 2.

FIG. 9 is a graph of the ratio of PrO⁺/CeO⁺ vs depth for the compositions of Example 4 and Example 5.

FIG. 10 is an SEM image of the composition of Example 2 with a scale bar of 200 nm.

FIG. 11 is an SEM image of the composition of Example 2 with a scale bar of 20 nm.

FIG. 12A is a light field TEM image of the composition of Example 2 with a scale bar of 200 nm. The box indicates the zoom area for FIG. 12B.

FIG. 12B is a light field TEM image of the composition of Example 2 with a scale bar of 20 nm. The box indicates the zoom area for FIG. 12C.

FIG. 12C is a light field TEM image of the composition of Example 2 with a scale bar of 5 nm.

FIG. 12D is a dark field TEM image of the composition of Example 2 with a scale bar of 5 nm.

FIG. 13A is the temperature programed desorption of CO₂ for the composition of Examples 6-9, which are antimicrobial compositions of Example 1 with PGM dispersed on the surface.

FIG. 13B is the temperature programed desorption of CO₂ for the composition of Examples 10-13, which are antimicrobial compositions of Example 2 with PGM dispersed on the surface.

FIG. 13C is the temperature programed desorption of CO₂ for the composition of Examples 14-16, which are antimicrobial compositions of Example 3 with PGM dispersed on the surface.

FIG. 14A is comparison of the Log reduction of E. coli for Examples 3, 15, and 9, which contain 1% Ru.

FIG. 14B is comparison of the Log reduction of S. aureus for Examples 3, 15, and 9, which contain 1% Ru.

FIG. 15A is comparison of the Log reduction of E. coli for Examples 3, 10, 13, and 7, which contain 0.1% Ru.

FIG. 15B is comparison of the Log reduction of S. aureus for Examples 3, 16, 10, 13, and 7, which contain 0.1% Ru.

### DETAILED DESCRIPTION

Before the compositions, articles, and methods are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a trivalent dopant” is not to be taken as quantitatively or source limiting, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Singular forms of the biological contaminants also include plural referents. For example, “amoeba” and “virus” include reference to “amoebae” and “viruses”, respectively.

Numerical values with “about” or “approximately” include typical experimental variances. As used herein, the terms “about” and “approximately” are used interchangeably and mean within a statistically meaningful range of a value, such as a stated weight percentage, surface area, concentration range, time frame, distance, molecular weight, temperature, pH, and the like. Such a range can be within an order of magnitude, typically within 10%, and even more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, at least every whole number integer within the range is also contemplated as an embodiment of the invention.

Precious metals, precious group metals, and PGM are used interchangeably and mean metals selected from copper (Cu), nickel (Ni), silver (Ag), palladium (Pd), platinum (Pt), ruthenium (Ru), gold (Au), osmium (Os), rhodium (Rh), or mixtures thereof.

A “low antimicrobial substrate” means a substrate having antimicrobial activity of less than 0.2 log reduction of the target contaminant.

The disclosed compositions have activity for removing biological contaminants. These compositions contain a trivalent doped CeO₂ particulate composition and precious metals, wherein the precious metals are dispersed on the surface of the particulate composition. As such, the precious metals are associated with/adhered to the surface of the particulate composition. The trivalent doped CeO₂ particulate compositions also are described as particulate oxide compositions and these terms are used interchangeably herein. This particulate oxide compositions are composed of mixed oxides of Ce and a trivalent dopant.

The compositions disclosed herein can be used as a slurry or in supported compositions and/or articles that are intended to remove biological contaminants and in methods for removing biological contaminants. These biological contaminants include bacteria, viruses, fungi, protozoa (e.g., amoebae), yeast, and mixtures thereof.

The antimicrobial compositions as disclosed herein contain precious metals and about 99.95 wt % to about 50 wt % of a particulate oxide composition, wherein the precious metals are dispersed on the surface of the particulate oxide composition and are selected from the group consisting of copper (Cu), nickel (Ni), silver (Ag), palladium (Pd), platinum (Pt), ruthenium (Ru), gold (Au), osmium (Os), rhodium (Rh), and mixtures thereof. As the weight % of the precious metals increase, the amount of the surface of the particulate oxide composition coated with the precious metals increases. One of skill in the art understands that if the composition contains about 50 wt % of the particulate oxide composition and about 50 wt % precious metals, approximately the entire surface of the particulate oxide composition is coated with the precious metals.

The antimicrobial compositions as disclosed herein exhibit unexpectedly better activity than the particulate oxide compositions alone. The antimicrobial compositions also unexpectedly exhibit better activity than the precious metals dispersed on a low antimicrobial substrate. Further, the activity when combined is unexpectedly synergistic, and as such, is more than merely additive.

The antimicrobial compositions as disclosed herein contain greater than about 50 wt % to about 99.95 wt % of a particulate oxide composition based on the total weight of the composition. The precious metals are present in a minority amount in comparison to the particulate oxide composition, and as such, the antimicrobial compositions contain more particulate oxide composition than precious metals.

In some embodiments, the antimicrobial compositions contain the precious metals in an amount of about 0.05 wt % up to about 50 wt % based on the total weight of the composition. In certain embodiments, the antimicrobial compositions comprise the precious metals in an amount of about 0.1 wt % up to about 50 wt % based on the total weight of the composition.

In certain embodiments, the antimicrobial composition comprises the precious metals in an amount of about 0.05 wt % to about 25 wt % based on the total weight of the composition or in an amount of about 0.1 wt % to about 25 wt % based on the total weight of the composition. In other embodiments, the antimicrobial composition comprises the precious metals in an amount of about 0.05 wt % to about 10 wt % based on the total weight of the composition or in an amount of about 0.1 wt % to about 10 wt % based on the total weight of the composition. In further embodiments, the antimicrobial composition comprises the precious metals in an amount of about 0.05 wt % to about 8 wt % based on the total weight of the composition or in an amount of about 0.1 wt % to about 8 wt % based on the total weight of the composition. In yet further embodiments, the antimicrobial composition comprises the precious metals in an amount of about 0.05 wt % to about 5 wt % based on the total weight of the composition or in an amount of about 0.1 wt % to about 5 wt % based on the total weight of the composition. It is understood that any of these embodiments of the weight % amounts of the precious metals can be combined with any of the below described embodiments of the particulate oxide composition. It is advantageous to use as low weight % of the precious metals as feasible and achieve an acceptable removal of the target biological contaminant(s).

The precious metals as dispersed on the surface are present as metallic or as oxides. In certain embodiments, the precious metals are silver (Ag), palladium (Pd), platinum (Pt), ruthenium (Ru), or mixtures thereof, and in particular embodiments, the precious metals are silver (Ag), ruthenium (Ru), or a mixture thereof.

In a specific embodiment, the precious metal dispersed on the surface of the particulate oxide composition is ruthenium. In certain of these embodiments, the antimicrobial composition comprises ruthenium in an amount of about 0.05 wt % to about 5 wt % based on the total weight of the composition or in an amount of about 0.05 wt % to about 3 wt % based on the total weight of the composition or in an amount of about 0.1 wt % to about 3 wt % based on the total weight of the composition. It is understood that these embodiments with ruthenium can be combined with any of the below described embodiments of the particulate oxide composition.

In another specific embodiment, the precious metal dispersed on the surface of the particulate oxide composition is silver. In certain of these embodiments, the antimicrobial composition comprises silver in an amount of about 0.05 wt % to about 0.3 wt % based on the total weight of the composition or in an amount of about 0.1 wt % based on the total weight of the composition. It is understood that these embodiments with silver can be combined with any of the below described embodiments of the particulate oxide composition.

The antimicrobial compositions as described herein contain a reduced amount of precious metals and exhibit effective activity, wherein the activity is unexpectedly synergistic (i.e., not merely additive) in view of the activity of the particulate oxide composition alone or precious metals in a similar amount on a low antimicrobial substrate.

As described above, the antimicrobial composition contains a particulate oxide composition with the precious metals dispersed on the surface. The particulate oxide composition comprises cerium oxide; trivalent dopant (as an oxide) selected from the group consisting of yttrium (Y), lanthanum (La), neodymium (Nd), praseodymium (Pr), and mixtures thereof; and optionally an additional metal oxide selected from the group consisting of aluminum (Al), titanium (Ti), zirconium (Zr), hafnium (Hf), and mixtures thereof. In this particulate oxide, the cerium oxide is present in an amount greater than the trivalent dopant and the average trivalent dopant to Ce ratio at about 0 nm to about 3.5 nm from the surface of the particulate oxide composition is greater than the trivalent dopant to Ce ratio at about 15 nm from the surface of the particulate composition.

In certain embodiments of the particulate oxide composition, it comprises cerium oxide in an amount of about 99.9 wt % to about 20 wt % based on the total weight of the particulate oxide composition; trivalent dopant in an amount of about 0.1 wt % up to about 50 wt % based on the total weight of the particulate oxide composition; and additional metal oxide in an amount of about 70 wt % to about 0 wt % based on the total weight of the particulate oxide composition.

Within the antimicrobial composition, the particulate oxide composition is composed primarily of mixed oxides of Ce and a trivalent dopant. These particulate oxide compositions are also described herein as trivalent doped CeO₂ compositions or trivalent doped CeO₂ particulate compositions.

As such, the trivalent doped CeO₂ particulate compositions are mixed oxides of Ce and of a trivalent dopant. In the particulate oxide compositions, the trivalent dopant is selected from the group consisting of yttrium (Y), lanthanum (La), neodymium (Nd), praseodymium (Pr), and mixtures thereof.

In certain embodiments, the particulate oxide compositions also contain an amount of additional metal oxide. This additional metal oxide is selected from the group consisting of aluminum (Al), titanium (Ti), zirconium (Zr), hafnium (Hf), and mixtures thereof.

Within the antimicrobial composition, the trivalent doped CeO₂ compositions or particulate oxide compositions comprise cerium oxide and one or more trivalent dopants (as oxides) and optionally one or more additional metal oxides. As such, the particulate oxide composition comprises cerium oxide, trivalent dopant selected from the group consisting of yttrium (Y), lanthanum (La), neodymium (Nd), praseodymium (Pr), and mixtures thereof (as oxides), optionally one or more additional metal oxides, other than the cerium oxide and trivalent dopant, and/or trace amounts of impurities.

The additional metal oxides within the particulate oxide composition are selected from the group consisting of aluminum, titanium, zirconium, hafnium, and mixtures thereof. In certain embodiments, the particulate oxide composition contains about zero additional metal oxides. In other embodiments, the particulate oxide composition contains additional metal oxides.

The cerium of the cerium oxide in the particulate oxide composition is Ce(IV). The trivalent rare earth dopants can be selected from the group consisting of yttrium (Y), lanthanum (La), neodymium (Nd), praseodymium (Pr), samarium (Sm), europium (Eu), gadolinium (Gd), terbium (Tb), dysprosium (Dy), holmium (Ho), erbium (Er), thulium (Tm), ytterbium (Yb), lutetium (Lu), cerium (Ce), and mixtures thereof. In certain embodiments, the trivalent dopant is yttrium (Y), lanthanum (La), neodymium (Nd), praseodymium (Pr), and mixtures thereof, and in particular embodiments, the trivalent dopant is Nd, La, or a mixture thereof. In other embodiments, the trivalent dopant is La. In additional embodiments, the trivalent dopant is Pr. As described, the trivalent dopant is present within the particulate composition as an oxide so that the particulate oxide composition comprises a mixed oxide of at least cerium and trivalent dopant.

The trivalent dopant is present in a minority amount in comparison to the cerium oxide, and as such, the particulate oxide compositions contain more cerium oxide than trivalent dopant (also present as an oxide).

The particulate oxide composition optionally also may contain additional metal oxides, other than the cerium oxide and trivalent dopant. These additional metal oxides may be selected from the group consisting of aluminum (Al), titanium (Ti), zirconium (Zr), hafnium (Hf), and mixtures thereof.

As such, the particulate oxide composition is a mixed oxide composition (i.e., a mixture of oxides of at least cerium and trivalent dopant). The composition also is identified herein as a trivalent doped cerium oxide, and when identified as such, it is a mixed cerium trivalent dopant oxide, but this description does not exclude the additional metal oxides, unless it is identified that the composition contains about zero additional metal oxides, other than the cerium and trivalent dopant.

In certain embodiments of the particulate oxide composition, the trivalent dopant is La and the particulate oxide composition does contain about zero additional metal oxides. In these embodiments, the particulate oxide composition is a mixed cerium lanthanum oxide (or a La doped cerium oxide).

The particulate oxide composition comprises the trivalent dopant (as an oxide) in an amount of about 0.1 wt % up to about 50 wt % based on the total weight of the particulate oxide composition. As stated above, the trivalent dopant is present in a minority amount in comparison to the cerium oxide. In certain embodiments, the particulate oxide composition contains the trivalent dopant in an amount of about 0.5 wt % to about 40 wt % or in an amount of about 1 wt % to about 40 wt % based on the total weight of the particulate oxide composition. In particular embodiments, the particulate oxide composition contains the trivalent dopant in an amount of about 2 wt % to about 35 wt % or in an amount of about 2 wt % to about 30 wt % based on the total weight of the particulate oxide composition. In additional embodiments, the particulate oxide composition contains the trivalent dopant in an amount of about 2 wt % to about 25 wt % or in an amount of about 5 wt % to about 20 wt % based on the total weight of the particulate oxide composition. In specific of these embodiments, the particulate oxide composition contains the trivalent dopant in an amount of about 15 wt % based on the total weight of the particulate oxide composition. The trivalent dopant is present within the particulate composition as an oxide and these wt % are based on trivalent dopant as an oxide. In certain of any of the above-described embodiments, the trivalent dopant is lanthanum and the particulate oxide composition is cerium oxide doped with lanthanum (i.e., a mixed oxide of cerium and lanthanum).

In embodiments where the particulate oxide composition contains a cerium oxide, one or more trivalent dopants, and about zero additional metal oxide, the amount of cerium oxide will correspond to and vary with the amount of trivalent dopant so that the total amount of the trivalent dopant (as an oxide) and cerium oxide is about 100% of the particulate composition. In certain of these embodiments with about zero additional metal oxide, the trivalent dopant is lanthanum, and the particulate oxide composition is cerium oxide doped with lanthanum.

In the particulate oxide compositions, the cerium oxide is present in an amount greater than trivalent dopant. The particulate oxide composition as disclosed herein generally comprises the cerium oxide in an amount of about 99.9 wt % to about 20 wt % based on the total weight of the particulate oxide composition. In certain embodiments, the particulate oxide composition contains the cerium oxide in an amount of about 99.9 wt % to about 50 wt %. In certain embodiments, the particulate oxide composition contains the cerium oxide in an amount of about 99.5 wt % to about 25 wt % or in an amount of about 99 wt % to about 30 wt % based on the total weight of the particulate oxide composition. In particular embodiments, the particulate oxide composition contains the cerium oxide in an amount of about 98 wt % to about 65 wt % or in an amount of about 98 wt % to about 70 wt % based on the total weight of the particulate oxide composition. In additional embodiments, the particulate oxide composition contains the cerium oxide in an amount of about 98 wt % to about 75 wt % or in an amount of about 95 wt % to about 80 wt % based on the total weight of the particulate oxide composition. In specific of these embodiments, the particulate oxide composition contains the cerium oxide in an amount of about 85 wt % based on the total weight of the particulate oxide composition. The amount of cerium oxide will vary with and correspond to the amount of trivalent dopant, and any amount of optional additional metal oxide, so that the total amount is about 100% of the particulate composition.

In specific embodiments, the particulate oxide composition comprises about zero wt % additional metal oxides, and in these embodiments, the particulate oxide composition comprises the cerium oxide in an amount to provide about 100% of the particulate composition based on the weight % of trivalent dopant. For example, in embodiments containing the trivalent dopant in an amount of about 0.1 wt % up to about 50 wt % based on the total weight of the particulate oxide composition, the composition contains cerium oxide in an amount of about 99.9 wt % to about 50 wt %. In an embodiment containing the trivalent dopant in an amount of about 1 wt % to about 40 wt % based on the total weight of the particulate oxide composition, the composition contains cerium oxide in an amount of about 99 wt % to about 60 wt %. In an embodiment containing the trivalent dopant in an amount of about 2 wt % to about 30 wt % based on the total weight of the particulate oxide composition, the composition contains cerium oxide in an amount of about 98 wt % to about 70 wt %, and the like.

As described herein, the particulate oxide composition optionally may contain additional metal oxides other than the cerium oxide and trivalent dopant. These additional metal oxides may be selected from the group consisting of aluminum (Al), titanium (Ti), zirconium (Zr), hafnium (Hf), and mixtures thereof. The particulate oxide composition as disclosed herein generally comprises the additional metal oxide in an amount of about 70 wt % to about 0 wt % based on the total weight of the particulate oxide composition.

In certain embodiments, the particulate oxide comprises cerium oxide in an amount of about 99.9 wt % to about 20 wt % based on the total weight of the particulate oxide composition; trivalent dopant in an amount of about 0.1 wt % up to about 50 wt % based on the total weight of the particulate oxide composition; and additional metal oxide in an amount of about 70 wt % to about 0 wt % based on the total weight of the particulate oxide composition. In the particulate oxide composition, the cerium oxide is present in an amount greater than trivalent dopant.

When additional metal oxides are present, the particulate oxide composition generally comprises these additional metal oxides in an amount of about 70 wt % to about 0.1 wt % based on the total weight of the particulate oxide composition. In certain embodiments, the particulate oxide composition contains these additional metal oxides in an amount of about 50 wt % to about 0.1 wt % or in an amount of about 30 wt % to about 0.1 wt % based on the total weight of the particulate oxide composition. In certain embodiments, the particulate oxide composition contains these additional metal oxides in an amount of about 10 wt % to about 0.1 wt % based on the total weight of the particulate oxide composition. In other embodiments, the particulate oxide composition contains about zero wt % additional metal oxides. The amount of additional metal oxide will vary with and correspond to the amount of trivalent dopant and cerium oxide so that the total amount is about 100% of the particulate composition.

In one embodiment, the particulate oxide composition comprises trivalent dopant in an amount of about 2 wt % to about 25 wt % based on the total weight of the particulate oxide; cerium oxide in an amount of about 20 wt % to about 30 wt %; and additional metal oxide in an amount of about 45 wt % to about 78 wt %. In the particulate oxide compositions, the cerium oxide is present in an amount greater than trivalent dopant and the amounts of the components will vary and correspond so that the total amount is about 100% of the particulate composition.

In an alternative embodiment, the particulate oxide composition comprises trivalent dopant in an amount of about 2 wt % to about 25 wt % based on the total weight of the particulate oxide; cerium oxide in an amount of about 45 wt % to about 78 wt %; and additional metal oxide in an amount of about 20 wt % to about 30 wt %. In the particulate oxide compositions, the cerium oxide is present in an amount greater than trivalent dopant and the amounts of the components will vary and correspond so that the total amount is about 100% of the particulate composition.

The particulate oxide composition optionally may further contain impurities in a minor amount. These impurities are typically present in an amount of about 1% by weight or less (to about zero or to an amount that is undetectable) based on the total weight of the particulate oxide composition. These impurities include residual solvents, salts, other metals, and the like. These other metals include those commonly found in water, such as magnesium, iron, calcium, silicon, sodium, and the like. These impurity amounts (of about 1% by weight to about zero or to an amount that is undetectable) may be present in any of the above and below described embodiments of the particulate oxide compositions. When present and detectable, any impurities are generally present in an amount of about 100 ppm or less.

The particulate oxide compositions as disclosed herein have a unique depth profile for the distribution of the cerium oxide and the trivalent dopant. This unique depth profile means that there is a higher ratio of trivalent dopant to Ce closer to the surface of the particulate oxide composition in comparison to deeper within the particulate oxide composition.

With regard to the depth profile, one of skill in the art recognizes that these particulate oxide compositions have a surface, and this surface is referred to as at about 0 nm. One of skill in the art understands how to measure the Ce and trivalent dopant from this surface (i.e., at 0 nm) to depths (measured in nm) within the particulate oxide composition and from this measurement can calculate trivalent dopant to Ce ratios and an average trivalent dopant to Ce ratio at different depths.

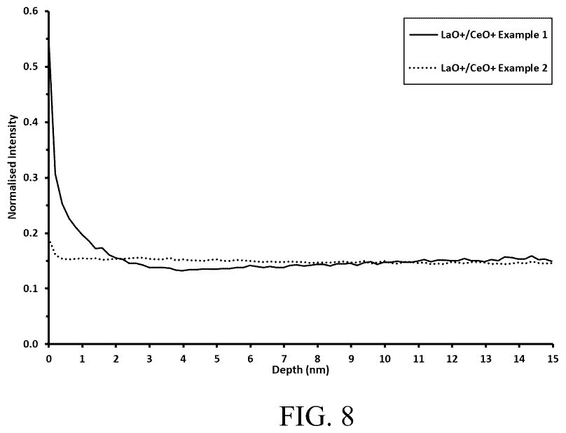

The unique depth profile of the particulate oxide composition is characterized such that the average trivalent dopant to Ce ratio at about 0 nm (i.e., the surface) to about 3.5 nm from the surface of the particulate oxide composition is greater than the trivalent dopant to Ce ratio at about 15 nm from the surface of the particulate oxide composition. Measurements of the Ce and trivalent dopant are taken at certain intervals from 0 nm (i.e., the surface) to about 3.5 nm and then averaged. Measurement of the Ce and trivalent dopant is also taken at about 15 nm from the surface of the particulate composition. FIG. 8 is a graph of the ratio of LaO⁺/CeO⁺ vs depth and demonstrates this unique depth profile for one example of particulate oxide composition to be used within the antimicrobial compositions.

The depth profile for the distribution of cerium oxide and trivalent dopant is measured by Time of Flight (ToF) Secondary Ion Mass Spectrometry (SIMS) Depth profilometry as described in Noel, C. et al. ToF-SIMS Depth Profiling of Organic Delta Layers with Low-Energy Cesium Ions: Depth Resolution Assessment, Journal of The American Society for Mass Spectrometry, Vol. 30 (2019) pp 1537-1544, the contents of which are incorporated by reference in their entirety. As one of skill in the art understands, a square section of a particle of the sample material is chosen and analyzed by ToF-SIMS which yields the analysis at a depth of 0 nm (i.e., at the surface). ToF-SIMS works by bombarding the target material with an ion beam, which causes the material to sputter. Sputtering is a phenomenon where microscopic particles are ejected from the surface of a solid material. The ejected particles are then analyzed by mass in the mass spectrometer. The ion source for the ToF-SIMS analysis in this disclosure was a cesium ion source run at 2 keV with a target current of 130 nA; the sputtering size was 500 μm²; the analysis area was 200 μm², 2 frames analysis followed by 6 frames sputter, and 60 seconds sputter time. The selected square section is then etched with an ion beam to remove the surface atoms. In this disclosure, a primary ion beam was a bismuth liquid metal ion gun run at 30 keV with pulsed target current of approximately 0.6 pA; the sputtering size was 250 μm²; the analysis area was 100 μm², 2 frames analysis followed by 50 frames sputter, and 20,000 seconds sputter time. The time of the etching is correlated to the depth of the etching, and thus the depth can be controlled. In this disclosure, the sputter depth was calibrated to 1 nm/s. The exposed surface is then reanalyzed by ToF-SIMS to give the analysis at the new depth. The particulate composition can be analyzed in any increments of nm, for example, in increments of about 0.2 nm, increments of about 0.5 nm, increments of about 1 nm, and the like. This process is repeated until the desired depth is obtained. The observed mass spectrometry data is then correlated to the depth at which it was collected. For the present disclosure, it is important to determine the ratio of trivalent dopant to Ce, and thus, this is the reported data.

The unique depth profile for the particulate oxide compositions provides unique structural (i.e., physical) and electrochemical properties and may contribute to the improved activity for removing biological contaminants when used in the antimicrobial compositions.

In one embodiment, the particulate oxide composition of the antimicrobial composition comprises cerium oxide, trivalent dopant (as an oxide) selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate composition is greater than the trivalent dopant to Ce ratio at about 15 nm from the surface of the particulate oxide composition. In one embodiment of this particulate oxide composition, the composition comprises about 0.1 wt % up to about 50 wt % trivalent dopant. In a certain embodiment, the composition further comprises about 99.9 wt % to about 50 wt % cerium oxide based on the total weight of the particulate oxide composition.

Another embodiment disclosed herein is a particulate oxide composition comprising cerium oxide and trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant, wherein the average trivalent dopant to Ce ratio at about 0 nm to about 3.5 nm from the surface of the particulate composition is greater than the trivalent dopant to Ce ratio at about 15 nm from the surface of the particulate oxide composition, and wherein the composition comprises about 2 wt % to about 30 wt % trivalent dopant. In one embodiment of this particulate oxide composition, the composition comprises cerium oxide in an amount of about 98 wt % to about 70 wt % based on the total weight of the particulate oxide composition.

It can be appreciated that the particulate oxide compositions containing trivalent doped CeO₂ having the described depth profile can have any of the above-described amounts of trivalent dopant, cerium oxide, and optional additional metal oxide.

In particular embodiments, the particulate oxide composition contains cerium oxide and trivalent dopant with only minor amounts to no (i.e., about zero) additional metal oxides and only 1% to no (i.e., zero or undetectable) amounts of impurities. When present and detectable, any impurities are generally present in an amount of about 100 ppm or less.

In certain embodiments, the particulate oxide compositions have an average trivalent dopant to Ce ratio at about 0 nm to about 3.5 nm from the surface of the particulate oxide composition that is about 10% to about 250% greater than the trivalent dopant to Ce ratio at about 15 nm from the surface of the particulate oxide composition. In other embodiments, the particulate oxide compositions have an average trivalent dopant to Ce ratio at about 0 nm to about 3.5 nm from the surface of the particulate oxide composition that is about 15% to about 250% greater than the trivalent dopant to Ce ratio at about 15 nm from the surface of the particulate oxide composition. As stated above, it is understood that 0 nm from the surface of the particulate oxide composition is the surface of the particulate oxide composition.

It can be appreciated that the particulate oxide compositions containing trivalent doped CeO₂ having the above-described depth profile also can have any of the above-described amounts of trivalent dopant, cerium oxide, and optional additional metal oxide, and the below described additional properties.

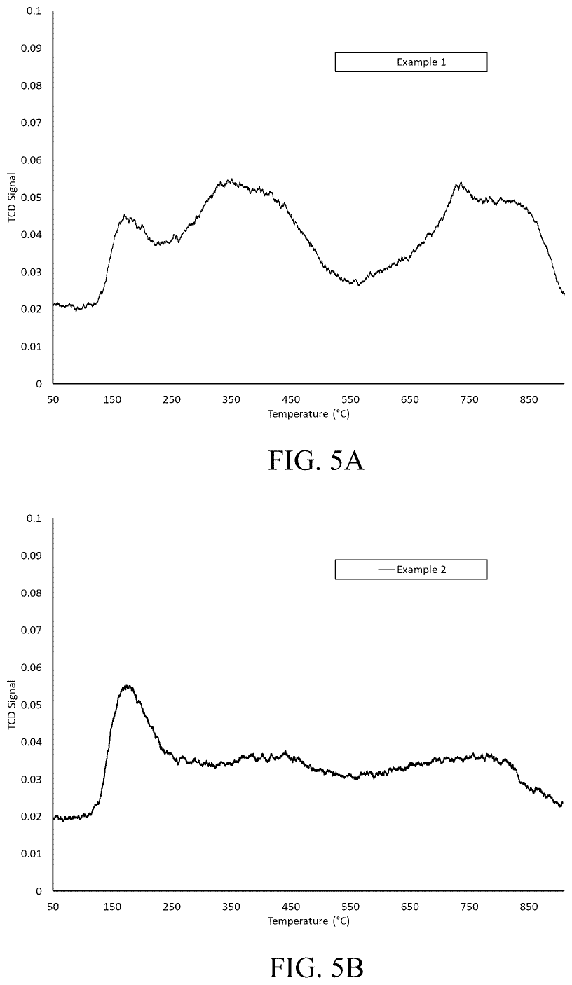

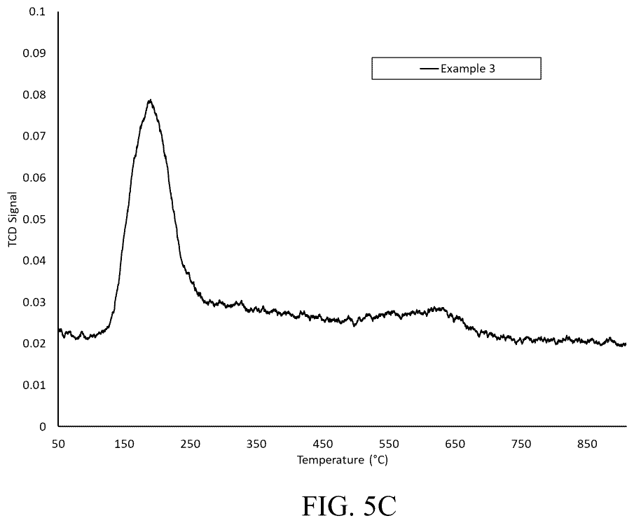

The particulate oxide compositions containing trivalent doped CeO₂ having the unique depth profile also can exhibit unique physical characteristics, including for example, exhibiting both physisorption and chemisorption of CO₂ (see FIGS. 5A, 5B, and 5C). Physisorption also is known as physical adsorption and is a weak association, such as through van der Waals. Chemisorption also is known as chemical adsorption. In chemisorption, adsorption takes place, and the adsorbed substance is bound by chemical bonds. This is a much stronger adsorption than physisorption. Exhibiting physisorption and chemisorption is a unique characteristic of the particulate compositions containing trivalent doped CeO₂ having the above-described depth profile. Since the adsorbant is CO₂ (an acid), exhibiting chemisorption indicates the material is more basic and may provide improved activity for removing biological contaminants. This property of exhibiting physisorption and chemisorption may be combined with any of the above-described depth profiles and any of the above-described amounts of trivalent dopant, cerium oxide, and optional additional metal oxide, as well as the below described additional properties.

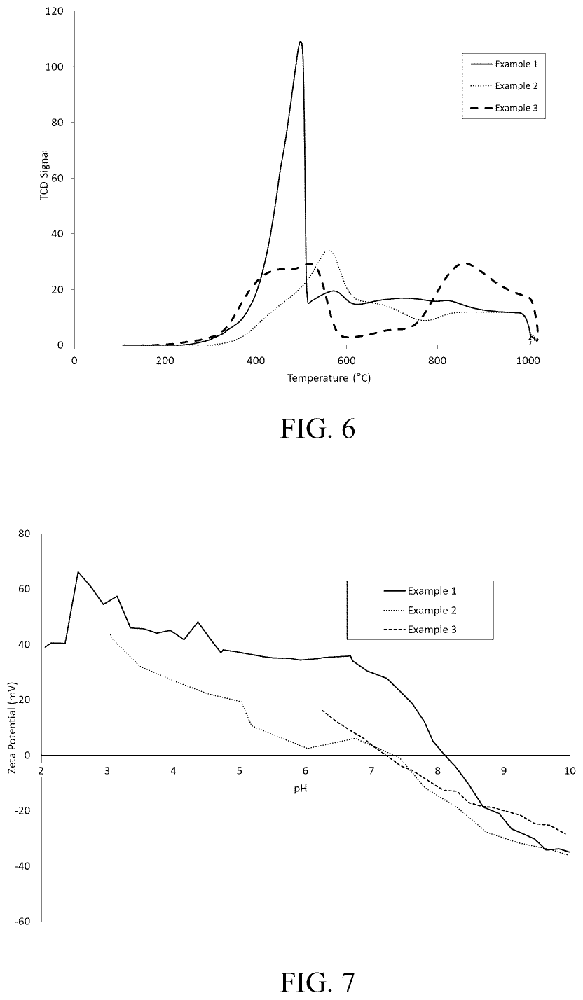

The particulate oxide compositions with the unique depth profile also can be more readily reduced than compositions made by prior art methods, and thus, these compositions are more oxidizing. FIG. 6 is a graph of the temperature program hydrogen reduction of material from Examples 1, 2, and 3. Example 1 has a large sharp peak at a lower temperature. This peak indicates that this novel particulate oxide composition (of Example 1) is more easily reduced as compared to the compositions of Example 2 or 3. Thus, the particulate oxide compositions having a unique depth profile can be more oxidizing, and thus, more effective for removing/reducing biological contaminants. The graph for Example 2 has essentially the same shape as Example 1 but it is shifted to higher temperatures, which indicates more energy is needed for the material to react with hydrogen and would thus it would be less oxidizing than Example 1. The graph for Example 3, which is undoped cerium oxide, shows two peaks for hydrogen reduction that are broad and not very tall. This would indicate there are two types of reductions that could take place with this material and the higher temperature one is much more difficult to achieve.

This hydrogen reduction temperature and more oxidate property also can be combined with any of the above-described depth profiles, physical properties, and any of the above-described amounts of trivalent dopant, cerium oxide, and optional additional metal oxide, as well as the below described additional properties.

The particulate oxide compositions containing trivalent doped CeO₂ and having the unique depth profile as disclosed herein further can exhibit more basicity as indicated by its isoelectric point and zeta potential (see FIG. 7). In certain embodiments, the particulate oxide composition as described herein has an isoelectric point at a pH of about 8 to about 9. In additional embodiments, the particulate oxide composition as described herein has a zeta potential of about 20 to about 40 mV at a pH of about 7. Having a higher isoelectric point indicates the material is more basic and may provide improved activity for removing biological contaminants. This property also can be combined with any of the above-described depth profiles, physical properties, and any of the above-described amounts of trivalent dopant, cerium oxide, and optional additional metal oxide, as well as the below described additional properties.

The particulate oxide compositions containing trivalent doped CeO₂ also can have a surface area that assists in the precious metals adhering to the surface and that provides improved biological contaminant removal properties.

As described herein, the surface area is the apparent surface area of the compositions as determined by using a Micromeritics ASAP 2000 system and nitrogen at about 77 Kelvin. The procedure outlined in ASTM International test method D 3663-03 (Reapproved 2008) was used but with one significant exception. It is well known that a “BET Surface Area” determination is not possible for materials that contain microporosity. Recognizing that the surface area is an approximation, the values reported are labeled “apparent surface area” values rather than “BET surface area” values. In compliance with commonly accepted procedures, the determination of apparent surface area, the application of the BET equation was limited to the pressure range where the term na(1−P/Po) of the equation continuously increases with P/Po. The out gassing of the sample was done under nitrogen at about 300 degrees Celsius for about 2 hours.

The particulate oxide compositions containing trivalent doped CeO₂ can have a surface area of about 70 m²/g to about 300 m²/g. It can be appreciated that the particulate oxide compositions having this surface area can have the below-described average pore volume in combination with any one or more of the depth profile and the other above-described properties, as well as any of the above-described amounts of trivalent dopant, cerium oxide, and optional additional metal oxide.

The particulate oxide compositions typically have an average (mean, median, and mode) pore volume (as determined by N₂ adsorption) of about 0.01 cm³/g to about 1.5 cm³/g. While not wanting to be bound by any theory it is believed that the average pore volume can affect and improve the removal of the biological contaminant from an aqueous or gaseous stream.

It can be appreciated that the particulate oxide compositions can have the above-described average pore volumes in combination with any one or more of the above surface areas, depth profile, and the other above-described properties, as well as any of the above-described amounts of trivalent dopant, cerium oxide, and optional additional metal oxide.

The particulate oxide compositions containing cerium oxide and one or more trivalent dopants and with precious metals dispersed on the surface can effectively remove biological contaminants. These antimicrobial compositions, containing the particulate oxide compositions with precious metals dispersed on the surface, are capable of removing approximately 90% or more of the biological contaminants. In certain embodiments, these antimicrobial compositions are capable of removing approximately 99% or more of the biological contaminants.

These antimicrobial compositions exhibit surprisingly better activity than the particulate oxide compositions alone or the precious metals dispersed on a low antimicrobial substrate. The activity also is unexpectedly synergistic (i.e., not merely additive) in view of the activity of the particulate oxide composition alone or precious metals in a similar amount on a low antimicrobial substrate. As such, the antimicrobial compositions as disclosed herein allow for use of a reduced amount of precious metal (e.g., silver or ruthenium) while maintaining efficacy for removing biological contaminants.

The antimicrobial compositions can be slurried with a biological contaminant-containing aqueous stream and effectively remove the biological contaminants. In some embodiments, slurrying the antimicrobial compositions with a biological contaminant-containing aqueous stream removes at least about 90% of the biological contaminant. In other embodiments, the slurrying removes at least 95%, or more preferably 99% or 99%+ of the biological contaminant.

The antimicrobial compositions as described herein also can be incorporated into supported compositions and/or articles for removing biological contaminants as described infra.

### Supported Compositions and Articles

Also disclosed herein are supported compositions comprising a support material and the antimicrobial compositions containing the trivalent doped CeO₂ particulate compositions with precious metals dispersed on the surface of the particulate composition. These supported compositions are for removing biological contaminants. The supported compositions comprise a support material and the antimicrobial compositions containing precious metals and particulate oxide composition comprising cerium oxide doped with a trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant, wherein the precious metals are dispersed on the surface of the particulate oxide composition.

As described, the particulate oxide composition comprises cerium oxide, one or more trivalent dopants (as oxides), and optionally the additional metal oxides, other than the cerium oxide and trivalent dopant, and/or trace amounts of impurities. In certain embodiments, the particulate oxide composition contains about zero additional metal oxides. The particulate oxide composition has the unique depth profile wherein the cerium oxide is present in amount greater than the trivalent dopant and wherein the average trivalent dopant to Ce ratio at about 0 nm to about 3.5 nm from the surface of the particulate oxide composition is greater than the trivalent dopant to Ce ratio at about 15 nm from the surface of the particulate composition. The particulate oxide compositions in the antimicrobial compositions within the supported compositions include all of the embodiments for the particulate oxide composition as described supra.

The antimicrobial compositions comprise the particulate oxide composition in an amount of about 50 wt % to about 99.95 wt % based on the total weight of the antimicrobial composition. In the antimicrobial compositions, the particulate oxide composition is present in amount greater than the precious metals.

The precious metals are metals are selected from the group consisting of copper (Cu), nickel (Ni), silver (Ag), palladium (Pd), platinum (Pt), ruthenium (Ru), gold (Au), osmium (Os), rhodium (Rh), and mixtures thereof. In certain embodiments, the precious metals are silver, ruthenium, or a mixture thereof. The antimicrobial compositions within the supported compositions include all of the embodiments for the precious metals as described supra.

The supported compositions for removing biological contaminants also comprise a support material. This support material comprises an organic polymer, cotton, glass fiber, or mixtures thereof.

The organic polymer can be a homopolymer of organic monomers or a co-polymer. The organic polymer also can be a silicone or polysiloxane (i.e., a polymer made up of siloxane (—R₂Si—O—SiR₂—, where R=organic group)). The organic polymer also can be a thermoset polymer, such as a thermoplastic elastomer. In certain embodiments, the organic polymer is selected from the group consisting of polyethylene, polycarbonate, polyvinyl chloride, nylon, polypropylene, polyester, polyurethane, polyamide, polyolefin, copolymers thereof, and mixtures thereof. In certain embodiments, the organic polymer is silicone.

In the supported compositions as disclosed herein, the antimicrobial composition is deposited on or within the support material.

In one embodiment of the supported composition, the particulate oxide composition, of the antimicrobial composition, comprises cerium oxide in an amount of about 99.9 wt % to about 20 wt % based on the total weight of the particulate oxide composition; trivalent dopant (as an oxide) in an amount of about 0.1 wt % up to about 50 wt % based on the total weight of the particulate oxide composition; and additional metal oxide in an amount of about 70 wt % to about 0 wt % based on the total weight of the particulate oxide composition.

In another embodiment of this supported composition, the particulate oxide composition, of the antimicrobial composition, comprises about 0.1 wt % up to about 50 wt % trivalent dopant and about 99.9 wt % to about 50 wt % cerium oxide based on the total weight of the particulate oxide composition.

In the supported compositions, it can be appreciated that the antimicrobial compositions can have any of the above-described embodiments of particulate oxide composition and precious metals.

These supported compositions comprise a support material comprising an organic polymer, cotton, glass fiber, or mixtures thereof and the antimicrobial composition containing the particulate oxide composition having the unique depth profile and precious metals, wherein the precious metals are dispersed on the surface of the particulate oxide composition. As described, this particulate oxide composition is a mixed oxide composition (i.e., a mixture of oxides of the cerium, trivalent dopant, and optionally additional metal oxides). In these supported compositions, the antimicrobial composition containing precious metals and particulate oxide composition (i.e., the trivalent doped cerium oxide having the unique depth profile) is deposited on or within the support material.

In all embodiments, the supported compositions contain approximately 0.5 to approximately 80 weight % antimicrobial composition based on the total weight of the supported composition. In certain embodiments, the supported compositions contain approximately 0.5 to approximately 50 weight % antimicrobial composition based on the total weight of the supported composition. In other embodiments, the supported compositions contain approximately 0.5 to approximately 25 weight % antimicrobial composition based on the total weight of the supported composition. In yet other embodiments, the supported compositions contain approximately 0.5 to approximately 10 weight % antimicrobial composition based on the total weight of the supported composition. In additional embodiments, the supported compositions contain approximately 0.5 to approximately 5 weight % antimicrobial composition based on the total weight of the supported composition. In these supported compositions, it can be appreciated that the antimicrobial compositions can have any of the above-described embodiments of particulate oxide composition and precious metals.

The supported composition containing the support material and the antimicrobial composition can be in a rigid or elastic form. The supported composition can form an article for removing biological contaminants, such as a filter or a plastic (such as a plastic container). The article can be in a rigid or elastic form.

When the supported composition forms an article, the article contains about 50 to about 100 weight % of the supported composition containing the support material and the antimicrobial composition based on the total weight of the article. In certain embodiments, the article contains about 75 to about 95 weight % of the supported composition containing the support material and the antimicrobial composition based on the total weight of the article.

When the antimicrobial composition and support are formed into an elastic or rigid article, the article also may include binder, sand, gravel, glass wool, a metal or plastic container, and the like.

In some embodiments, the support material can be an organic polymer. In certain of these embodiments, the trivalent dopant of the particulate oxide composition is Pr, La, or a mixture thereof and the precious metal is Ag, Ru, or a mixture thereof. When this supported composition using an organic polymer as the support material forms an article, the article can be a plastic article. In these embodiments, the organic polymer can be selected from the group consisting of polyethylene, polyvinyl chloride (PVC), nylon, polypropylene, polyester, polyurethane, polyamide, polyolefin, polycarbonate, copolymers thereof, and mixtures thereof. In specific embodiments, the organic polymer is polyethylene, polycarbonate, or mixtures thereof. When a plastic, the article can be in the form of a filter, bottle, container, or a plastic covering for a high touch service. The filter can be a fixed bed. The bottle or container may be for liquids. High touch surfaces include escalator or stair handrail covering, an elevator button covering, a door, a door handle or knob or covering therefore, coverings on public transportation, touch pads for electronic transactions, and the like.

In some embodiments, the support material can be cotton. In certain of these embodiments, the trivalent dopant of the particulate oxide composition is Pr, La, or a mixture thereof and the precious metal is Ag, Ru, or a mixture thereof. When this supported composition using cotton as the support material forms an article, the article can be a filter or a fabric.

In some embodiments, the support material can be glass fiber. In certain of these embodiments, the trivalent dopant of the particulate oxide composition is Pr, La, or a mixture thereof and the precious metal is Ag, Ru, or a mixture thereof. When this supported composition using glass fiber as the support material forms an article, the article can be a filter, bottle, container, or high touch surface. The filter can be a fixed bed. High touch surfaces include an elevator button covering, a door, coverings on public transportation, touch pads for electronic transactions, and the like.

In certain embodiments, the support material can be cotton and an organic polymer. In certain of these embodiments, the organic polymer can be selected from the group consisting of nylon, polyester, polyamide, and mixtures thereof. In certain of these embodiments, the trivalent dopant of the particulate oxide composition is Pr, La, or a mixture thereof and the precious metal is Ag, Ru, or a mixture thereof. When this mixture as the support material forms an article, the article can be a filter or a fabric.

In certain embodiments, the support material can be glass fiber and an organic polymer. The organic polymer can be selected from the group consisting of polyethylene, polyvinyl chloride (PVC), nylon, polypropylene, polyester, polyurethane, polyamide, polyolefin, polycarbonate, copolymers thereof, and mixtures thereof. In certain of these embodiments, the organic polymer can be selected from the group consisting of polyethylene, polycarbonate, and mixtures thereof. In certain of these embodiments, the trivalent dopant of the particulate oxide composition is Pr, La, or a mixture thereof and the precious metal is Ag, Ru, or a mixture thereof. When this mixture as the support material forms an article, the article can be a filter, bottle, container, or high touch surface. The filter can be a fixed bed. High touch surfaces include escalator or stair handrail covering, an elevator button covering, a door, a door handle or knob covering, coverings on public transportation, touch pads for electronic transactions, and the like.

In some embodiments, the support material can be polyethylene or polycarbonate. In certain of these embodiments, the trivalent dopant of the particulate oxide composition is Pr, La, or a mixture thereof and the precious metal is Ag, Ru, or a mixture thereof. And when the supported composition forms an article, the article can be a plastic article and can be in the form of a filter, bottle, container, or plastic covering for a high touch surface. The filter can be a fixed bed.

In certain embodiments, the support material can be silicone. In certain of these embodiments, the trivalent dopant of the particulate oxide composition is Pr, La, or a mixture thereof and the precious metal is Ag, Ru, or a mixture thereof.

In a specific embodiment, the article is a plastic article. The plastic article can be in the form of a filter, bottle, container, or plastic covering for a high touch surface. The plastic article comprises a supported composition for removing biological contaminants comprising (i) an organic polymer selected from the group consisting of polyethylene, polyvinyl chloride, nylon, polypropylene, polyester, polyurethane, polyamide, polyolefin, polycarbonate, copolymers thereof, and mixtures thereof. The plastic article also comprises (ii) the antimicrobial composition comprising: (a) precious metals selected from the group consisting of copper (Cu), nickel (Ni), silver (Ag), palladium (Pd), platinum (Pt), ruthenium (Ru), gold (Au), osmium (Os), rhodium (Rh), and mixtures thereof and (b) particulate oxide composition. The particulate oxide composition comprises cerium oxide; trivalent dopant selected from the group consisting of yttrium (Y), lanthanum (La), neodymium (Nd), praseodymium (Pr), and mixtures thereof; and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate oxide composition is greater than the trivalent dopant to Ce ratio at about 15 nm from the surface of the particulate composition. The precious metals are dispersed on the surface of the particulate oxide composition and the particulate oxide composition is present in an amount greater than the precious metals. In certain of these embodiments, the trivalent dopant of the particulate oxide composition is Pr, La, or a mixture thereof and the precious metal is Ag, Ru, or a mixture thereof. And in certain of these embodiments of the plastic article, the organic polymer can be selected from the group consisting of polyethylene, polycarbonate, and mixtures thereof.

In all embodiments of the plastic article, the antimicrobial composition is deposited on or within the organic polymer. In certain embodiments, the plastic article comprises about 50 to about 100 weight percent of the supported composition for removing biological contaminants based on the total weight of the plastic article.

In certain embodiments of the plastic article, it comprises an antimicrobial composition containing (i) precious metals selected from the group consisting of silver, ruthenium, or mixtures thereof and (ii) about 99.95 wt % to about 50 wt % of a particulate oxide composition comprising about 0.1 wt % up to about 50 wt % trivalent dopant and about 99.9 wt % to about 50 wt % cerium oxide based on the total weight of the particulate oxide composition. This specific particulate oxide composition includes all of the embodiments for the particulate oxide composition as described supra.

The antimicrobial compositions containing precious metals and trivalent doped cerium oxide particulate composition wherein the precious metals are dispersed on the surface of the particulate composition, the supported compositions, and the articles as disclosed herein are capable of removing approximately 90% or more of the biological contaminants. In certain embodiments, the antimicrobial compositions, supported compositions, and articles as disclosed herein are capable of removing approximately 99% or more of the biological contaminants.

The biological contaminants to be removed by the articles, supported compositions, antimicrobial compositions, and methods disclosed herein include viruses, bacteria, fungi, (e.g., mold or fungus), protozoa (e.g., amoebae), algae, yeast, and the like, and mixtures thereof. In certain embodiments, the biological contaminants to be removed by the articles, compositions, and methods disclosed herein are selected from the group consisting of bacteria, viruses, fungi (e.g., mold), protozoa (e.g., amoebae), and mixtures thereof. In specific embodiments, the biological contaminants to be removed by the articles, compositions, and methods disclosed herein are bacteria, viruses, amoebae, and mixtures thereof. In other embodiments, the biological contaminants are bacteria, viruses, and mixtures thereof.

In certain embodiments the biological contaminants to be removed include those of concern in aqueous streams, such as wastewater, and those of concern which are airborne.

The bacteria include gram positive and gram negative bacteria. The bacteria include those commonly found in water, including fecal coliform bacteria. The bacteria include, for example, Streptococcus, Staphylococcus, Escherichia coli, Methicillin-resistant Staphylococcus aureus (MRSA), Legionella Pneumophila, Campylobacter Jejuni, Salmonella, Mycobacterium tuberculosis, Corynebacterium diphtheriae, Listeria monocytogenes, Bordetella pertussis, and the like. The viruses include, for example, rhinovirus, coronaviruses, vaccinia, poliovirus, varicella zoster virus, paramyxovirus, influenza virus, morbillivirus, hepatitis A virus (HAV), adenovirus (HAdV), rotavirus (RoV), sapovirus, respiratory syncytial virus (RSV), paramyxovirus, varicella-zoster virus (VZV), variola virus (including smallpox and monkey pox), and other enteric viruses, such as noroviruses (NoV), coxsackievirus, echovirus, reovirus and astrovirus, and the like. Other microbial contaminants include protozoa (such as Cryptosporidium) and specifically amoebae (such as Naegleria fowleri). Further microbial contaminants, which are fungi, include Trichophyton mentagrophytes and Aspergillus.

The articles, compositions, and methods disclosed herein reduce the concentration or amount of these biological contaminants.

### Method of Making the Antimicrobial Compositions and Trivalent Doped Cerium Oxide Particulate Oxide Compositions

There are known methods for making trivalent doped cerium oxide compositions (see for example U.S. patent application Ser. No. 17/870,068, the contents of which are hereby incorporated by reference in their entirety). There are also known method for making trivalent doped cerium oxide compositions having the unique depth profile and other unique properties as described supra (see for example U.S. patent application Ser. No. 17/895,942, the contents of which are hereby incorporated by reference in their entirety.

The antimicrobial compositions with the precious metals dispersed on the surface of the particulate oxide compositions as either metallic or oxides are prepared as described in the Examples, infra.

The method of making the antimicrobial compositions generally includes wetting the particulate oxide compositions with a solution of a soluble precious metal salt, optionally exposing that mixture to a reducing agent, evaporating the material to dryness under reduced pressure, and optionally drying or calcining the resulting solid at elevated temperatures.

As an example, a trivalent doped cerium oxide is wetted with a solution of ruthenium(III) nitrosyl nitrate in an amount to yield a final 1% Ru by weight concentration. Then hydrazine is added in an amount to reduce the ruthenium to ruthenium metal, and the liquid is removed by evaporation under reduced pressure.

In some embodiments, the antimicrobial composition is about 1 weight % ruthenium and about 99 weight % particulate oxide composition. The wetting of the particulate oxide can occur by placing the particulate oxide in a container, stirring the particulate oxide or rotating the container, followed by spraying, dripping, pumping, or pouring the solution of soluble precious metal salt into the container. The addition rate of the solution of soluble precious metal salt and mixing time should be sufficient to allow for proper wetting and mixing of the materials. The optional reducing agent can be any reagent with sufficient reducing potential to reduce the precious metal to the metallic state, for example, hydrazine, hydrogen, reducing acids such as carboxylic acids (i.e. citric acid, acetic acid, oxalic acid, and the like), alcohols, metal hydrides, and hydrogen peroxide. The drying of the antimicrobial material can occur at reduced pressure, elevated temperature, or a combination thereof. Further heating or calcining is optional, and if utilized can occur in a furnace, rotary kiln, or the like.

### Preparing Supported Compositions and Articles

The supported compositions contain a support material and the antimicrobial composition of precious metals and particulate oxide composition, wherein the precious metals are dispersed on the surface of the particulate oxide composition. The particulate oxide composition comprises cerium oxide and trivalent dopant and having the unique depth profile as described supra. The particulate oxide composition, antimicrobial composition, supported compositions, and articles include all of the embodiments described herein. In the supported composition, the support material is selected from an organic polymer, cotton, glass fiber, or mixtures thereof.

The supported composition independently may be used for treating gaseous or aqueous mixtures. Or the supported composition may be incorporated into an article specifically designed for treating gaseous or aqueous mixtures, such as a filter or a plastic container. The filter may be a fixed bed. The filter may be used for a gaseous or aqueous mixture or stream and thus to filter the gaseous or aqueous mixture or stream.

In supported compositions and in articles containing supported compositions, the antimicrobial composition is deposited onto a support material or within the support material to provide the supported composition for removing biological contaminants.

The antimicrobial composition can be deposited on one or more external and/or internal surfaces of the support material. It can be appreciated that persons of ordinary skill in the art generally refer to the internal surfaces of the support material as pores. The antimicrobial composition can be deposited on or incorporated into the surface of the support material. The antimicrobial composition as described herein can be supported on the support material with or without a binder. In some embodiments, the antimicrobial composition can be applied to the support material using any conventional techniques, such as slurry deposition.

Processes of preparing the supported compositions are not limited by any particular steps or methods, and generally can be any that result in the incorporation of the antimicrobial composition into a support material or deposited onto a support material. Processes to incorporate the antimicrobial composition into a support material include mixing the antimicrobial composition into the support material production. As an example, the antimicrobial composition can be added to molten polypropylene in the molding process. As another example, the antimicrobial composition can be added to a mixture of polyvinyl chloride resin, a plasticizer, and a stabilizer and passed through a hot mixer followed by an extruder.

Processes to deposit the antimicrobial composition onto a support material include mixing the antimicrobial composition with an organic binder either as a liquid or in an aqueous solution. The mixture of antimicrobial composition and organic binder is then bound to the support material by immersion of the support material or by coating the support material with the mixture by spreading or air brushing. The organic binder also can be used in slurry deposition techniques.

In certain embodiments, the organic binder is selected from the group consisting of citric acid, polyurethane diol, polyvinyl alcohol, polyvinylpyrollidone, linseed oil, and mixtures thereof. Once the antimicrobial composition is bound to the support material, the support as coated optionally may be rinsed with water prior to drying to remove residual not bound to the support. The coated support can then be optionally dried at temperatures above about 20° C. and below about 300° C. for about 1-12 hours or until sufficiently dry. In certain embodiments, the coated support can then be optionally dried at temperatures above about 20° C. and below about 120° C.

In the case of support materials that can melt, such as glass or plastics, the support can be heated to the point where the surface just begins to soften, then the antimicrobial composition can be placed on the surface such that it begins to mix with the semi-molten material. Upon cooling and resolidifying the antimicrobial composition is incorporated into the surface of the support material. The temperature utilized would depend on the support material utilized. One of skill in the art readily would be able to determine the appropriate temperature for the support material being utilized. For example, this temperature for quartz glass would be over 1000° C.; borosilicate glass would be about 500-600° C.; and PVC would be about 200-300° C.

These solid supports can be utilized to form articles including filters and plastic articles.

The antimicrobial compositions also may be incorporated into an article for a high touch surface and this high touch surface may come into contact with biological contaminants by direct touch contact. As such, articles for high touch surfaces also may be utilized in reducing bacteria and/or viruses deposited through contact and not necessarily just in treating fluids. These articles may be containers for liquids, elevator buttons, hand railing covers for escalators or stairs, a door, door handle, doorknob, coverings on public transportation, touch pads for electronic transactions, fabrics, and the like.

The supported compositions containing the antimicrobial composition and support material can be formed into an elastic or rigid article, such as a filter, a fixed bed filtration system, a bottle or container, a high touch surface, and the like. In specific embodiments the article is a plastic article. In other embodiments, the article is a filter. These articles may contain any additional necessary components that such articles ordinarily contain, as well recognized by those of skill in the art. Techniques for forming these articles are well known to those of skill in the art.

### Methods for Using the Antimicrobial Compositions

The present application relates to methods for removing biological contaminants using any of the above disclosed antimicrobial compositions containing trivalent doped cerium oxide with precious metals dispersed on the surface. The methods can utilize the antimicrobial compositions per se, or the methods can utilize the antimicrobial compositions as part of a supported composition or an article. The methods can treat a fluid, including air and aqueous and gaseous streams.

In these methods, the antimicrobial compositions exhibit surprisingly better activity than the particulate oxide compositions alone or the precious metals dispersed on a low antimicrobial substrate. The activity also is unexpectedly synergistic (i.e., not merely additive) in view of the activity of the particulate oxide composition alone or precious metals in a similar amount on a low antimicrobial substrate.

In some embodiments, supported compositions comprising the antimicrobial composition and a support material may be used independently in methods for removing biological contaminants, or the supported compositions of the antimicrobial composition and support material may be incorporated into an article specifically designed for treating gaseous or aqueous mixtures, such as a filter or a plastic (such as a plastic container).

The antimicrobial composition used within these methods comprises (a) about 99.95 wt % to about 50 wt % of a particulate oxide composition comprising: cerium oxide; trivalent dopant selected from the group consisting of yttrium (Y), lanthanum (La), neodymium (Nd), praseodymium (Pr), and mixtures thereof; and optionally an additional oxide selected from the group consisting of aluminum (Al), titanium (Ti), zirconium (Zr), hafnium (Hf), silicon (Si) and mixtures thereof, wherein the cerium oxide being present in an amount greater than the trivalent dopant and wherein the average trivalent dopant to Ce ratio at about 0 nm to about 3.5 nm from the surface of the particulate oxide composition is greater than the trivalent dopant to Ce ratio at about 15 nm from the surface of the particulate composition. The antimicrobial compositions further comprise (b) precious metals dispersed on the surface of the particulate oxide composition, wherein the precious metals are selected from the group consisting of copper (Cu), nickel (Ni), silver (Ag), palladium (Pd), platinum (Pt), ruthenium (Ru), gold (Au), osmium (Os), rhodium (Rh), and mixtures thereof.

The antimicrobial compositions can have any of the above-described embodiments of precious metals and particulate oxide composition.

In certain embodiments of the methods, the present application relates to methods for removing and ensuring a target concentration or less of biological contaminants using the disclosed antimicrobial compositions containing precious metals and trivalent doped cerium oxide. These biological contaminants include bacteria, viruses, protozoa (e.g., amoebae), fungi, algae, yeast, and the like. These methods can use the antimicrobial compositions per se, supported compositions containing the antimicrobial compositions, and articles containing these supported compositions.

The methods may treat fluids (e.g., an aqueous stream, gaseous stream, or mixture thereof) or surfaces of solid objects through touch/direct contact. As such, the methods disclosed herein include methods for treating fluids (e.g., aqueous and/or gaseous streams).

In certain embodiments of the methods, an aqueous or gaseous stream is contacted with the antimicrobial composition of precious metals and the particulate oxide compositions. The particulate oxide compositions include all of the embodiments described supra, including any of the above-described amounts of trivalent dopant, cerium oxide, and optional additional metal oxide, and any of the above-described properties. The antimicrobial compositions include all of the embodiments described supra, including any of the above-described precious metals and amounts of precious metals.

In other embodiments of the methods, an aqueous or gaseous stream is contacted with the supported compositions containing the antimicrobial compositions as described herein. In yet other embodiments of the methods, a potentially contaminated surface is contacted with the supported compositions or articles containing the antimicrobial compositions as described herein. These potentially contaminated surfaces include, for example, skin (e.g., a hand, finger, palm, etc.) and the contact is through touching the supported compositions or articles containing the antimicrobial compositions as described herein. In the methods as disclosed, the biological contaminant to be removed may be contained within an aqueous or gaseous stream or may be on the surface of the physical object.

While not wanting to be bound by any theory, it is believed that the contacting of the antimicrobial composition containing the particulate oxide composition with precious metals dispersed on the surface as described herein with the biological contaminant leads to the biological contaminant one or more of sorbing and/or reacting with the precious metals and/or trivalent doped cerium oxide or deactivating when contacted with the precious metals and/or trivalent doped cerium oxide. The sorbing, reacting, and/or deactivating of the biological contaminant with the precious metals and/or trivalent doped cerium oxide removes the biological contaminant from the biological contaminant-containing fluid (air or aqueous stream) or the solid surface.

The biological contaminant may be removed to a target level or to below a target level. In some embodiments the biological contaminant may be removed to a level at which it is undetectable. The target level may be a specified amount or the limit of detection. As part of the methods described herein, the biological contaminant to be removed may be identified and the target amount or level for the contaminant may be set. For certain of the biological contaminants contemplated herein, the target amount or level would be any detectable amount. The methods optionally may additionally comprise monitoring the treated stream for the contaminant.

The methods disclosed herein may be used to treat air or water or may be used to treat contaminants through contact by touch. When used to treat contaminants by contact through touch, the disclosed antimicrobial compositions are incorporated into a high touch surface.

Using the disclosed antimicrobial compositions to treat biological contaminated air and/or water allows for the efficient operation of air and/or water treatment methods and provides a treated stream with reduced concentrations of biological contaminant. As disclosed herein, the antimicrobial compositions may be incorporated into a supported composition and those supported composition may be incorporated into an article specifically designed for treating gaseous or aqueous mixtures, such as a filter, a fixed bed filtration system, or in a plastic for a container. In methods of treating aqueous streams, the antimicrobial compositions also may be used per se and contacted through slurrying. In these methods involving slurrying, the method may further comprise filtering the fluid/liquid.

In any of these methods, the antimicrobial compositions can have any of the above-described types and amounts of precious metals and any of the above-described embodiments and amounts of the particulate oxide compositions. As such, the particulate oxide compositions can have any of the above-described amounts of trivalent dopant, cerium oxide, and optional additional metal oxide, and any of the above-described properties. The particulate oxides compositions within the antimicrobial composition have the unique depth profile.

Although the methods of the disclosure are envisioned for removing biological (e.g., bacterial, viral, amoebae, etc.) contaminants from air and/or drinking water and groundwater, it will be understood that the process can be used to treat any gaseous or aqueous liquid feed that contains undesirable amounts of biological contaminants. The methods also are envisioned for removing biological contaminants through direct contact of a contaminated surface with an article containing the antimicrobial compositions as disclosed herein.

In certain embodiments, these methods of removing biological contaminants comprise the step of (i) providing an antimicrobial composition comprising: (a) a particulate oxide composition comprising cerium oxide; trivalent dopant selected from the group consisting of yttrium (Y), lanthanum (La), neodymium (Nd), praseodymium (Pr), and mixtures thereof; and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate composition is greater than the trivalent dopant to Ce ratio at about 15 nm from the surface of the particulate composition, and (b) precious metals dispersed on the surface of the particulate oxide composition, wherein the precious metals are selected from the group consisting of copper (Cu), nickel (Ni), silver (Ag), palladium (Pd), platinum (Pt), ruthenium (Ru), gold (Au), osmium (Os), rhodium (Rh), and mixtures thereof. The method further comprises the steps of (ii) contacting the antimicrobial composition with a biological contaminant wherein the biological contaminant is selected from the group consisting of bacteria, viruses, fungi, protozoa, and mixtures thereof; and (iii) removing biological contaminant through contact with the antimicrobial composition. The biological contaminant can be contained in an aqueous or liquid stream or on the surface of an object that is physically contacted with the antimicrobial composition. These methods remove at least about 90% of the biological contaminant through contact with the antimicrobial composition. In certain embodiments, the methods remove approximately 99% or more of the biological contaminants through contact with the antimicrobial composition.

In some embodiments, the antimicrobial composition may be contained within a supported composition and in certain of these embodiments, the supported composition may be incorporated into an article. These methods may further comprise monitoring for the biological contaminant after contacting. The monitoring may be done by sampling or may be continuous.

In certain embodiments, these methods comprise the step of (i) providing a supported composition comprising a support material comprising an organic polymer, cotton, glass fiber, or mixtures thereof and an antimicrobial composition (as disclosed herein) comprising (a) a particulate oxide composition and (b) precious metals dispersed on the surface of the particulate oxide composition. The methods further comprise the steps of (ii) contacting the supported composition with a biological contaminant wherein the biological contaminant is selected from the group consisting of bacteria, viruses, fungi (e.g., mold), protozoa (e.g., amoebae), and mixtures thereof; and (iii) removing the biological contaminant through contact with the supported composition. These methods remove at least about 90% of the biological contaminant.

In certain of these methods, the particulate oxide composition within the antimicrobial composition comprises cerium oxide in an amount of about 99.9 wt % to about 20 wt % based on the total weight of the particulate oxide composition; trivalent dopant in an amount of about 0.1 wt % up to about 50 wt % based on the total weight of the particulate oxide composition; and additional metal oxide in an amount of about 70 wt % to about 0 wt % based on the total weight of the particulate oxide composition. In certain of these methods, the antimicrobial compositions comprise precious metals selected from silver, ruthenium, or mixtures thereof.

The biological contaminant can be contained in an aqueous or liquid stream or on the surface of an object that is physically contacted with the supported composition. These methods may further comprise monitoring for the biological contaminant after contacting. The monitoring may be done by sampling or may be continuous.

The antimicrobial compositions include any of the above-described embodiments of the precious metals and particulate oxide composition, as described supra.

The contacting of the antimicrobial composition with the biological contaminant leads to removal of a measurable amount of the biological contaminant. In some embodiments, the contacting removes at least about 90% of the biological contaminant. In other embodiments, the contacting removes at least 95%, or more preferably 99% or 99%+ of the biological contaminant.

Contacting of the antimicrobial composition with biological contaminant effectively reduces the amount of biological contaminant, and in certain embodiments, it effectively reduces the amount of biological contaminant in a gaseous or aqueous stream. The removal also can be expressed as a percent reduction in concentration of the biological contaminant. In some embodiments, the contacting of the antimicrobial composition with the biological contaminant can reduce its concentration by more than about 75%. More typically, the contacting of the antimicrobial composition with the biological contaminant can reduce its concentration by more than about 80%, more typically more than about 85%, more typically more than about 90%, more typically more than about 95%, more typically more than about 97.5%, more typically more than about 99%, and even more typically more than about 99.5%.

In specific embodiments, these methods may be for removing biological contaminants from fluid or for treating fluid. In these embodiments, the fluid may be a gaseous, aqueous stream, or mixture thereof. In these embodiments, the methods may use either the antimicrobial compositions per se, a supported composition, or an article as described herein. As such, the methods comprise (i) providing an antimicrobial composition, supported composition, or article as described herein. If in a supported composition, the support material comprises an organic polymer, cotton, glass fiber, or mixtures thereof and the antimicrobial composition as disclosed herein. The method further comprises (ii) contacting a biological contaminant containing gaseous or aqueous stream with the antimicrobial composition, wherein the biological contaminant is selected from the group consisting of bacteria, viruses, fungi (e.g., mold), protozoa (e.g., amoebae), and mixtures thereof; and (iii) removing biological contaminant from the gaseous or aqueous stream through contact with the antimicrobial composition. The biological contaminant can be removed in an amount of 90% or more. These methods may further comprise monitoring for the biological contaminant after contacting. The monitoring may be done by sampling or may be continuous.

In these methods, the antimicrobial compositions and the precious metals and the particulate oxide compositions within the antimicrobial composition include all of the embodiments as described supra.

In these methods of treating a gaseous or aqueous stream, the method may further comprise a step of setting a target concentration of biological contaminant. In these methods a biological contaminant of interest is identified and then a target concentration for that biological contaminant is set. The methods additionally may comprise a step of monitoring the biological contaminant in the treated stream. The monitoring may be done by sampling or may be continuous.

In certain embodiments, the methods comprise the steps of (i) providing a composition comprising a support material comprising an organic polymer, cotton, glass fiber, or mixtures thereof and the antimicrobial composition as described herein an antimicrobial composition (as disclosed herein) containing the particulate oxide composition and precious metals; (ii) setting a target concentration of a biological contaminant; (iii) contacting a gaseous or aqueous stream with the antimicrobial composition, and removing biological contaminant through contact with the antimicrobial composition to provide a treated stream; and (iv) monitoring the treated stream for the biological contaminant, wherein the biological contaminant is selected from the group consisting of bacteria, viruses, fungi (e.g., mold), protozoa (e.g., amoebae), and mixtures thereof. The antimicrobial compositions and the precious metals and the particulate oxide compositions within the antimicrobial composition include all of the embodiments as described supra. The target concentration can be set at a certain amount of contaminant (e.g., virus, bacteria, protozoa/amoebae, or fungi) or can be set at the limit of detection. Monitoring of the biological contaminant can be performed through techniques well known to those of skill in the art. The monitoring may be done by sampling or may be continuous. One of skill in the art understands real-time and continuous monitoring techniques for microbial contaminants, including viruses, bacteria, protozoa/amoebae, fungi, and the like. These techniques include optical techniques and cell counters.

In specific embodiments of treating an aqueous stream, the methods comprise the step of (i) providing the antimicrobial composition as described herein containing the particulate oxide composition and precious metals. The methods further comprise the steps of (ii) contacting the aqueous stream with the antimicrobial composition and removing biological contaminant through contact with the antimicrobial composition to provide a treated aqueous stream, wherein the biological contaminant is selected from the group consisting of bacteria, viruses, fungi (e.g., mold), protozoa (e.g., amoebae), and mixtures thereof. These methods may further comprise monitoring for the biological contaminant after contacting. The monitoring may be done by sampling or may be continuous. In specific embodiments the methods may further comprise setting a target concentration of a biological contaminant and monitoring the treated aqueous stream for the biological contaminant. The target concentration may be a specified amount or the limit of detection. In these methods, the antimicrobial composition may be contained within a supported composition or within a supported composition within an article or may be contacted by slurrying the antimicrobial composition per se with the aqueous stream. In methods involving slurrying, the method may further comprise filtering the fluid/liquid. In these methods, the antimicrobial composition and the particulate oxide and precious metals within the antimicrobial composition include all of the embodiments as described supra.

In specific embodiments of treating an aqueous stream, the methods comprise the step of: (i) providing a supported composition comprising a support material comprising an organic polymer, cotton, glass fiber, or mixtures thereof and an antimicrobial composition as described herein comprising (a) a particulate composition and (b) precious metals dispersed on the surface of the particulate oxide composition. The methods further comprise the steps of (ii) contacting the aqueous stream with the antimicrobial composition and removing biological contaminant through contact with the antimicrobial composition to provide a treated aqueous stream, wherein the biological contaminant is selected from the group consisting of bacteria, viruses, fungi (e.g., mold), protozoa (e.g., amoebae), and mixtures thereof. In these methods, the antimicrobial composition and the particulate oxide and precious metals within the antimicrobial composition include all of the embodiments as described supra. These methods may further comprise monitoring for the biological contaminant after contacting. The monitoring may be done by sampling or may be continuous. In specific embodiments the methods may further comprise setting a target concentration of a biological contaminant and monitoring the treated aqueous stream for the biological contaminant. The target concentration may be a specified amount or the limit of detection.

In specific embodiments of treating a gaseous stream, the methods comprise (i) providing a supported composition comprising a support material comprising an organic polymer, cotton, glass fiber, or mixtures thereof and an antimicrobial composition as described herein comprising (a) particulate composition and (b) precious metals dispersed on the surface of the particulate oxide composition. The methods further (ii) contacting the gaseous stream with the antimicrobial composition and removing biological contaminant through contact with the antimicrobial composition to provide a treated gaseous stream, wherein the biological contaminant is selected from the group consisting of bacteria, viruses, fungi (e.g., mold), protozoa (e.g., amoebae), and mixtures thereof. In these methods, the antimicrobial composition and the particulate oxide and precious metals within the antimicrobial composition include all of the embodiments as described supra. These methods may further comprise monitoring for the biological contaminant after contacting. The monitoring may be done by sampling or may be continuous. In specific embodiments the methods may further comprise setting a target concentration of a biological contaminant and monitoring the treated gaseous stream for the biological contaminant. The target concentration may be a specified amount or the limit of detection.

When the biological contaminant is bacteria or fungi/mold, the removal can be expressed as a % reduction that is determined by using Colony Forming Units (CFU). In these embodiments, the concentration of bacteria contaminant after contacting with the antimicrobial composition or a supported composition or article comprising the antimicrobial composition can be about 45 colony forming units CFU/ml to 5×10⁵ CFU/ml.

When the biological contaminant is bacteria and/or viruses, the removal can be expressed as a % reduction that is determined by using Most Probable Number (MPN) technique. Most Probable Number (MPN) is used to estimate the concentration of viable microorganisms in a sample by means of replicating liquid broth growth in ten-fold dilutions.

A target concentration for biological contaminant also can be set as a percentage reduction of the contaminant from prior to the method and then after contact in the method. In certain embodiments, this percent reduction can be about 75% to about 100% less. In other embodiments, this percent reduction can be about 80% to about 99.9%.

A target concentration for biological contaminant can be set at a limit of detection for that contaminant. As described above, in embodiments including setting a target concentration for biological contaminant, the methods may further comprise one or more of the following additional steps: identifying the biological contaminant of interest; setting the target concentration; and monitoring for the biological contaminant after the contacting step to determine or verify that the biological contaminant is below the target concentration. Depending on the biological contaminant, the target concentration can be any detectable amount of that contaminant and the methods as disclosed herein are effective in treating the aqueous or gaseous stream as long as no amount of that contaminant is detected in the treated stream.

In specific of these embodiments, the stream to be treated can be an aqueous stream and the targeted contaminant can be bacteria, virus, or protozoa (e.g., amoebae). For example, the stream to be treated is an aqueous or gaseous stream and the targeted contaminant can be E. coli, poliovirus, coronavirus, Naegleria fowleri, paramyxovirus, Mycobacterium tuberculosis, Legionella pneumophila, coronavirus, or a mixture thereof. In certain embodiments, the stream to be treated is an aqueous stream and the targeted contaminant is E. coli, poliovirus, Naegleria fowleri, Legionella pneumophila, coronavirus, or a mixture thereof. In certain embodiments, the stream to be treated is a gaseous stream and the targeted contaminant is paramyxovirus, Mycobacterium tuberculosis, coronavirus, or a mixture thereof. In certain embodiments, the viruses to be targeted are transmitted primarily by touch and include varicella-zoster virus (VZV), variola virus (including smallpox and monkey pox).

These specific methods comprise the step of (i) providing an antimicrobial composition as disclosed herein comprising: (a) particulate oxide composition and (b) precious metals dispersed on the surface of the particulate oxide composition. The methods further comprise (ii) setting a target concentration of a biological contaminant wherein the contaminant is selected from the group consisting of E. coli, poliovirus, coronavirus, Naegleria fowleri, paramyxovirus, Mycobacterium tuberculosis, Legionella pneumophila, coronavirus or a mixture thereof; (iii) contacting a gaseous or aqueous stream with the antimicrobial composition, and removing biological contaminant through contact with the antimicrobial composition to provide a treated stream; and (iv) monitoring the treated stream for the biological contaminant. The target concentration can be set at a certain amount of contaminant or can be set at the limit of detection. The method also can include a step of identifying the contaminant of interest prior to setting the target concentration.

In these methods, the antimicrobial composition and the particulate oxide and precious metals within the antimicrobial composition include all of the embodiments as described supra. The antimicrobial composition of step (i) also can be provided as part of a supported composition, and as such, further comprise a support material comprising an organic polymer, cotton, glass fiber, or mixtures thereof or as part of an article comprising a supported composition.

Examples of gaseous feeds that can be treated according to the methods as disclosed herein include, among others, building ventilation systems, aircraft or vehicle ventilation systems, and ambient room air. Examples of liquid feeds that can be treated according to the methods as disclosed herein include, among others, tap water, well water, surface waters, such as water from lakes, ponds and wetlands, waters for recreational activities, agricultural waters, wastewater from industrial processes, and geothermal fluids. Examples of other uses involving physical contact with biological contaminants rather than filter, include incorporation into a plastic for a container or a plastic to be incorporated into a high touch surface, such as elevator buttons, escalator railing covers, stair railing covers, touch pads for electronic transactions, doors, doorknobs, and the like. These high touch surfaces also may include glass or a mixture of glass and plastic.

The antimicrobial compositions can remove bacteria, viruses, protozoa (e.g., amoebae), fungi (e.g., mold), and other microbial contaminants, and in some embodiments remove the bacteria, viruses, protozoa (e.g., amoebae), fungi (e.g., mold), and mixtures thereof from a gaseous or liquid feed.

In one embodiment, the process is envisioned for removing biological contaminants from a gaseous or an aqueous stream using the antimicrobial compositions (as disclosed herein) comprising particulate oxide compositions and precious metals dispersed on the surface of the particulate oxide compositions. The gaseous stream can be one or more of an ambient air source or more supply air for a ventilation system that contains or may contain undesirable amounts of biological and/or other contaminants. The aqueous stream can be one or more of a drinking water and groundwater source that contains or may contain undesirable amounts of biological and/or other contaminants. Furthermore, the aqueous stream can include without limitation well waters, surface waters (such as water from lakes, ponds, and wetlands, including natural and man-made and water for recreational purposes), agricultural waters, wastewater from industrial processes, and geothermal waters.

In some embodiments, the biological contaminant-containing gaseous stream is passed through an inlet into a vessel at a temperature and pressure, usually at ambient temperature and pressure, such that the gas in the biological contaminant-containing gaseous stream remains in the gaseous state. In this vessel the biological contaminant-containing gaseous stream is contacted with the antimicrobial composition. The contacting of the antimicrobial composition with the biological contaminant-containing gaseous stream removes the biological contaminant. The contacting of the antimicrobial composition with the biological contaminant-containing gaseous stream leads to removal of a measurable amount of the biological contaminant and in some embodiments, removal of at least 90%, more preferably 95%, and even more preferably 99% or 99%+ of the biological contaminant. In these methods, the antimicrobial composition and the particulate oxide and precious metals within the antimicrobial composition include all of the embodiments as described supra.

In some embodiments, the biological contaminant-containing aqueous stream is passed through an inlet into a vessel at a temperature and pressure, usually at ambient temperature and pressure, such that the water in the biological contaminant-containing aqueous stream remains in the liquid state. In this vessel the biological contaminant-containing aqueous stream is contacted with the antimicrobial composition. The contacting of the antimicrobial composition with the biological contaminant-containing aqueous stream leads to removal of a measurable amount of the biological contaminant and in some embodiments, removal of at least 90%, more preferably 95%, and even more preferably 99% or 99%+ of the biological contaminant. In these methods, the antimicrobial composition and the particulate oxide and precious metals within the antimicrobial composition include all of the embodiments as described supra.

In some embodiments, the antimicrobial composition is in the form of a fixed bed. Moreover, the fixed bed containing the antimicrobial composition normally comprises particles containing the trivalent doped cerium oxide and precious metals dispersed on the surface. The antimicrobial composition can have a shape and/or form that exposes a maximum trivalent doped cerium oxide particle surface area with precious metals dispersed thereon to the gaseous or aqueous fluid with minimal back-pressure and the flow of the gaseous or aqueous fluid through the fixed bed. If desired, the antimicrobial composition may be in the form of a shaped body such as beads, extrudates, porous polymeric structures or monoliths. The antimicrobial composition can be supported as a layer and/or coating on such beads, extrudates, porous polymeric structures or monolith supports.

Contacting of the antimicrobial composition with a biological contaminant-containing fluid normally takes place at a temperature from about 1° C. to about 100° C., more normally from about 5° C. to about 40° C. Furthermore, the contacting of antimicrobial composition with a biological contaminant-containing aqueous stream commonly takes place at a pH from about pH 1 to about pH 11, more commonly from about pH 3 to about pH 9. The contacting of the antimicrobial composition with biological contaminant-containing fluid generally occurs over a period of time of more than about 30 seconds and no more than about 24 hours.

Generally, the antimicrobial compositions can be used to treat any biological contaminant, and in particular bacteria, viruses, protozoa (e.g., amoebae), fungi, yeast, and mixtures thereof.

Contacting of the antimicrobial compositions with a gaseous or aqueous stream containing the biological contaminant effectively can reduce the biological contaminant level in the gaseous or aqueous stream. Typically, the contacting of the antimicrobial composition with the biological contaminant can reduce its concentration by more than about 75%. More typically, the contacting of the antimicrobial composition with the biological contaminant can reduce its concentration by more than about 80%, more typically more than about 85%, more typically more than about 90%, more typically more than about 95%, more typically more than about 97.5%, more typically more than about 99%, and even more typically more than about 99.5%. When the biological contaminant is bacteria or mold, the % reduction can be determined by number using Colony Forming Units (CFU). When the biological contaminant is bacterial or viruses, the % reduction can be determined by Most Probable Number (MPN).

The method of treating air or water to remove biological contaminants comprises the steps of passing an air or water stream containing a first concentration of one or more undesired biological contaminants through a material, article, or supported composition comprising the antimicrobial composition and obtaining a treated air or water stream having a concentration of one or more undesired biological contaminants less than the first concentration.

In certain embodiments, the biological contaminants to be removed are viruses. After contacting with the article or supported composition comprising the antimicrobial composition, the concentration of virus can be equal to or less than a target concentration of virus. When an air or gaseous stream is to be treated, the contacted (or treated) stream has a concentration of virus equal to or less than a target concentration of virus. In particular of these embodiments, the viruses are coronavirus.

In certain embodiments, the biological contaminants to be removed are bacteria. After contacting with the article or supported composition comprising the antimicrobial composition, the concentration of bacteria can be equal to or less than a target concentration of bacteria. When an air or gaseous stream is to be treated, the contacted (or treated) stream has a concentration of bacteria equal to or less than a target concentration of bacteria. In particular of these embodiments, the bacteria are fecal coliform bacteria.

In certain embodiments, the biological contaminants to be removed are protozoa (e.g., amoebae). After contacting with the article or supported composition comprising the antimicrobial composition, the concentration of protozoa (e.g., amoebae) can be equal to or less than a target concentration of protozoa (e.g., amoebae). When an air or gaseous stream is to be treated, the contacted (or treated) stream has the concentration of protozoa (e.g. amoebae) equal to or less than a target concentration of protozoa (e.g., amoebae). In particular of these embodiments, the protozoa (e.g., amoebae) to be removed are Naegleria fowleri and/or Cryptosporidium.

In certain embodiments, the biological contaminants to be removed are fungi (e.g., mold). After contacting with the article or supported composition comprising the antimicrobial composition, the concentration of fungi can be equal to or less than a target concentration of fungi. When an air or gaseous stream is to be treated, the contacted (or treated) stream has a concentration of fungi equal to or less than a target concentration of fungi. In particular of these embodiments, the fungi to be removed are Trichophyton mentagrophytes and/or Aspergillus.

The concentration of contaminant after contacting with a supported composition or material or article comprising the antimicrobial composition can be about 45 colony forming units CFU/ml to 5×10⁵ CFU/ml. The target concentration can be set at a certain amount of contaminant (e.g., virus, bacteria, amoeba, fungi) CFU per ml or can be set at the limit of detection.

In some embodiments, the antimicrobial composition per se is slurried with the biological contaminant-containing aqueous stream. It can be appreciated that the antimicrobial composition containing precious metals and particulate oxide composition and the biological contaminant-containing aqueous stream are contacted when they are slurried. While not wanting to be bound by any theory, it is believed that some, if not most or all of the biological contaminant contained in the biological contaminant-containing aqueous stream is removed from the biological contaminant-containing aqueous stream by the slurring and/or contacting of the antimicrobial composition as described herein with the biological contaminant-containing aqueous stream. Following the slurring and/or contacting of the antimicrobial composition with the biological contaminant-containing aqueous stream, the slurry is filtered by any known solid liquid separation method. The antimicrobial composition and the particulate oxide and precious metals within the antimicrobial composition as utilized in these methods include all of the embodiments as described supra.

### EXAMPLES

The following Examples are provided to illustrate the trivalent doped cerium oxide composition and methods in more detail, although the scope of the invention is never limited thereby in any way.

Scanning electron microscope (SEM) images were collected using a FEG Zeiss ultra 55 (resolution 1 nm). Transmission electron microscope (TEM) images were collected using a FEI Titan Themis 200 (resolution 0.09 nm). Surface area, pore radius, and pore volume were measured by the BET/BJH method (ASTM D3663-20). The Hg-porosity and total Hg-pore volume were measured using a Micromeritics Autopore IV 9500 system. The procedures outlined in ASTM International test method D 4284-07 were followed. The particle size was measured using a Microtrac S3500. X-ray Diffraction was performed using a Bruker D2 Phaser X-Ray Diffactometer. The peak width at half height was used to determine the crystallite size. The zeta potential vs. pH was measured using a Malvern Panalytical (Zetaziser Nano ZS) ZEN3600 using a procedure similar to ASTM E2865-12(2018). As will be appreciated, crystallite sizes are measured by XRD or TEM and are the size of the individual crystals. The Dₓₓ sizes are the size of the particles that are made-up of the individual crystallites and is measured by laser diffraction. The temperature programmed desorption of CO₂ was performed as described in Hakim, A. et al. Temperature Programmed Desorption of Carbon Dioxide for Activated Carbon supported Nickel Oxide: The Adsorption and Desorption Studies, Advanced Materials Research, Vol. 1087 (2015) pp 45-49. The hydrogen temperature programmed reduction was performed as described in Hurst, N. W. et al. Temperature Programmed Reduction. Catalysis Reviews Science and Engineering, 24:2, 233-309. Depth profilometry was performed as described in Noel, C. et al. ToF-SIMS Depth Profiling of Organic Delta Layers with Low-Energy Cesium Ions: Depth Resolution Assessment, Journal of The American Society for Mass Spectrometry, Vol. 30 (2019) pp 1537-1544.

### Example 1

A trivalent doped cerium oxide composition was prepared by the following method. 68 g (0.297 mol) of lanthanum carbonate and 464 g (2.7 mol) cerium oxide were mixed with 200 ml of a 1.0 mol/L lanthanum nitrate solution. The ingredients were mixed for 2 hours. The mixture was then heated in a furnace to 550° C. for 2 hours to obtain 542 g of a mixed cerium lanthanum oxide which is approximately 15% lanthanum oxide by weight. This could also be called a La doped cerium oxide.

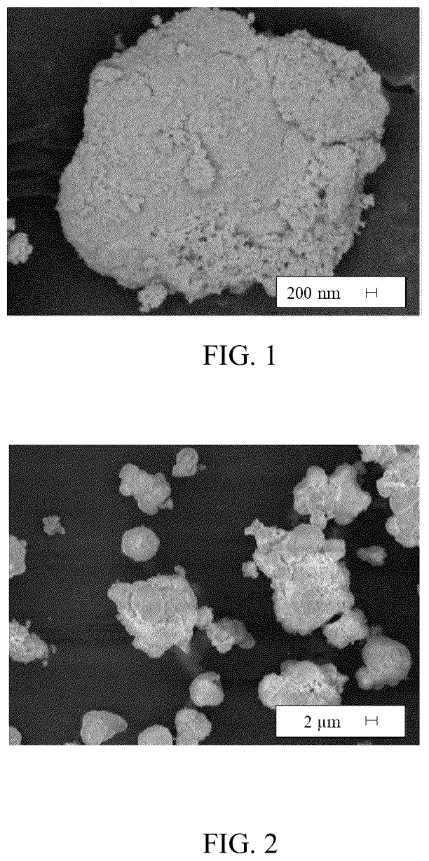

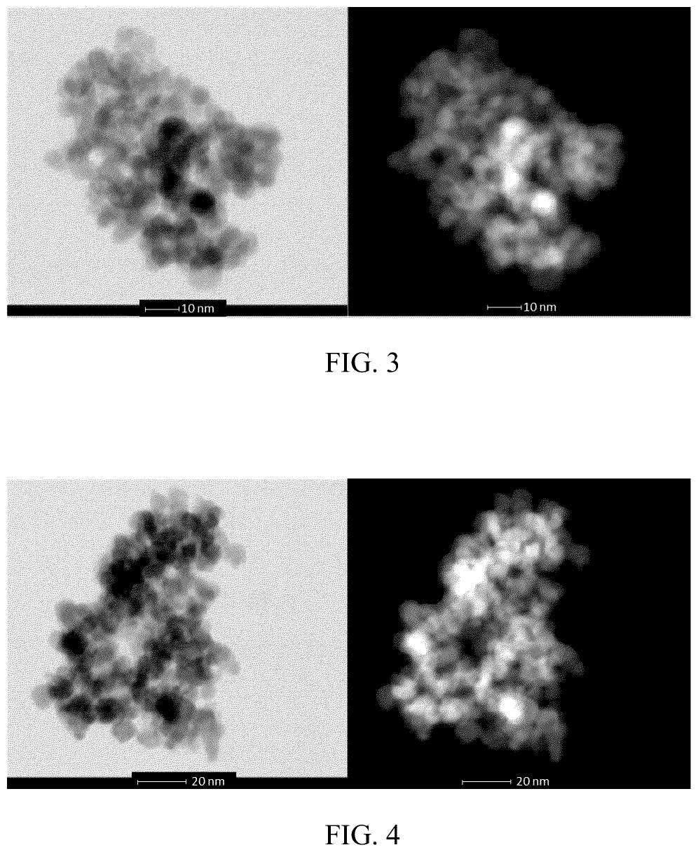

Scanning electron microscope (SEM) images for a sample of the example 1 composition were collected and are displayed in FIGS. 1 and 2. The images reveal a porous material that somewhat spherical in shape. Transmission electron microscope (TEM) images for a sample of the example 1 composition were collected and FIGS. 3 and 4 are the images. The images reveal clusters of spheres. A sample of the example 1 composition was analyzed for surface area, pore radius, and pore volume and found to be 98.332 m²/g (BET) and 135.268 m²/g (BJH) with a pore radius of 3.235 nm and pore volume of 0.248 cc/g. The measured Hg-porosity was measured to be 0.21 cc/g, with pore size <1 μm was 0.46 cc/g, and the total pore volume was 0.96 cc/g. The particle size distribution was measured as described above with the results being D10 3.552 μm, D50 12.1 μm, and D90 43.12 μm. The crystallite size as measured by XRD was determined to be 9.77 nm. The temperature programmed desorption profile is FIG. 5A. The desorption of CO₂ had 3 peak temperatures 172° C., 350° C. and 735° C. indicating both physisorption and chemisorption of CO₂. The H₂ TPR is depicted in FIG. 6 and shows an intense peak around 500° C. in stark contrast to examples 2 and 3 which had broader peaks. The zeta-potential as a function of pH is presented in FIG. 7. The isoelectric point (IEP) was found to be 8.1. The ratio of LaO⁺ to ¹⁴⁰CeO⁺ as a function of depth is plotted in FIG. 8. It should be noted the LaO⁺ to CeO⁺ ratio is higher at shallower depths and approaches a constant level as the depth increases. This indicates the concentration of La is higher on the surface and closer to the surface for the material from Example 1. The Example 1 material is an embodiment of the trivalent doped cerium oxide having the unique depth profile.

### Example 2

A trivalent doped cerium oxide composition was prepared by the following method also as described in U.S. patent application Ser. No. 17/870,068. 129 ml of a 1 mol/L Ce(NO₃)₄ solution was mixed with 24 ml of a 1 mol/L La(NO₃)₃ solution. The resulting solution was heated to reflux for at least 2 hours. 5.5 mol/L NH₄OH was then added to a pH of 10. The resulting solid was filtered and washed with DI water until the wash water was <15 mS/cm. The resulting powder was heated in a furnace in air at 550° C. for at least 2 hours to obtain a mixed cerium lanthanum oxide which is approximately 15% lanthanum oxide by weight. This could also be called a La doped cerium oxide.

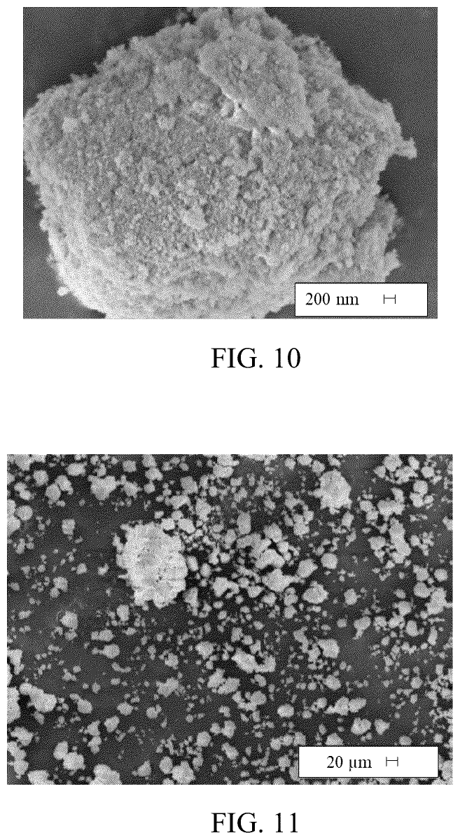

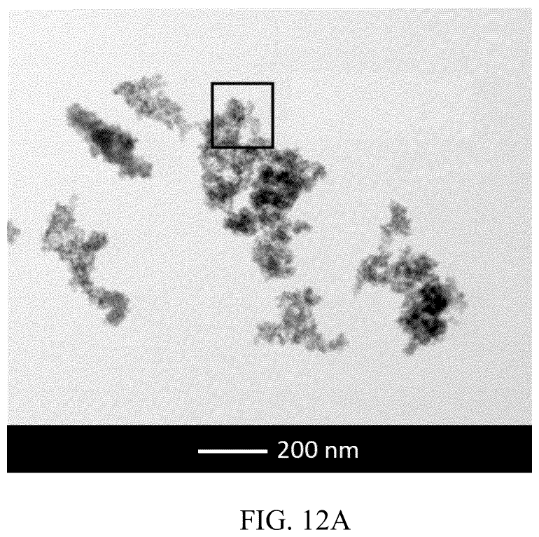

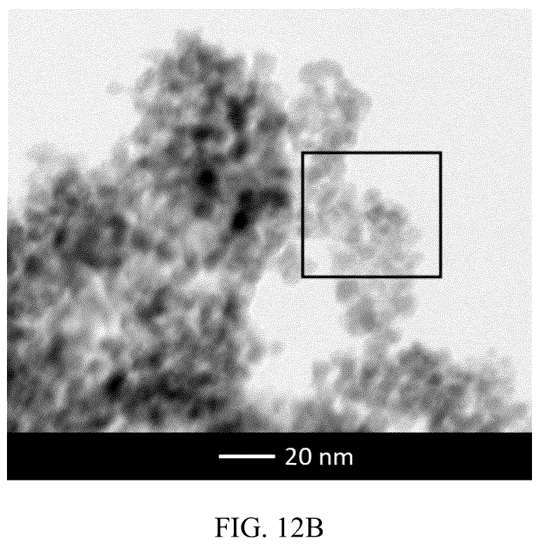

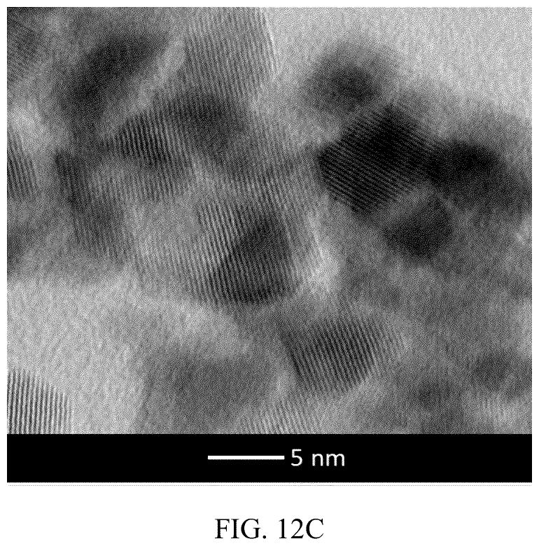

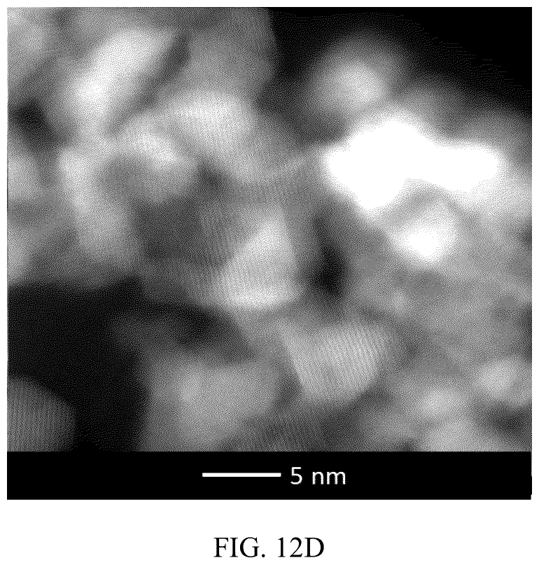

FIGS. 10 and 11 are the SEM images. The images reveal a porous material that somewhat spherical in shape. FIGS. 12A-12D contains the TEM images. The images reveal clusters of spheres and diffraction planes can be seen. The surface area was found to be 120.464 m²/g (BET) and 143.087 m²/g (BJH) with a pore radius of 3.245 nm and pore volume of 0.285 cc/g. The measured pore volume with pore size <0.1 μm was measured to be 0.23 cc/g, with pore size <1 μm was 0.45 cc/g, and the total pore volume was 0.99 cc/g. The particle size distribution was measured as described above with the results being D10 1.301 μm, D50 5.545 μm, and D90 13.109 μm. The crystallite size as measured by XRD was determined to be 9.03 nm. The temperature programmed desorption profile is FIG. 5B. The desorption of CO₂ had 1 peak temperature at 175° C. indicating only physisorption of CO₂. Any peaks at higher temperatures are not distinguished from the background and thus chemisorption of CO₂ is not detected. The H₂ TPR is depicted in FIG. 6 and shows a broad peak around 566° C. The zeta-potential as a function of pH is presented in FIG. 7. The isoelectric point (IEP) was found to be 7.34.

The ratio of LaO⁺ to ¹⁴⁰CeO⁺ as a function of depth is plotted in FIG. 8. It should be noted this material has a near constant LaO⁺ to CeO⁺ ratio from the surface to the maximum measured depth. This indicates the concentration of La is nearly the same on the surface as it is at depth.

### Example 3

A cerium (IV) oxide composition was prepared by the following method. In a closed, stirred container a one liter of a 0.12 M cerium (IV) ammonium nitrate solution was prepared from cerium (IV) ammonium nitrate crystals dissolved in nitric acid and held at approximately 90° C. for about 24 hours. In a separate container 200 ml of a 3M ammonium hydroxide solution was prepared and held at room temperature. Subsequently the two solutions were combined and stirred for approximately one hour. The resultant precipitate was filtered using Buchner funnel equipped with filter paper. The solids were then thoroughly washed in the Buchner using deionized water. Following the washing/filtering step, the wet hydrate was calcined in a muffle furnace at approximately 450° C. for three hours to form the cerium (IV) oxide composition.

The surface area was found to be 126 m²/g (BET) and 167 m²/g (BJH) with a pore radius of 3.62 nm and pore volume of 0.309 cc/g. The measured pore volume with pore size <0.1 μm was measured to be 0.24 cc/g, with pore size <1 μm was 0.35 cc/g, and the total pore volume was 0.85 cc/g. The particle size distribution was measured as described above with the results being D10 2 μm, D50 9 μm, and D90 25 μm. The crystallite size as measured by XRD was determined to be 8.43 nm. The temperature programmed desorption profile is FIG. 5C. The desorption of CO₂ had 1 peak temperature at 175° C. indicating only physisorption of CO₂. Any peaks at higher temperatures are not distinguished from the background and thus chemisorption of CO₂ is not detected. The H₂ TPR is depicted in FIG. 6 and shows broad peaks around 500 and 900° C. The zeta-potential as a function of pH is presented in FIG. 7. The isoelectric point (IEP) was found to be 7.22.

Depth profilometry was not performed as Ce was the only component in this sample. This sample contained no trivalent dopant.

### Example 4

A trivalent doped cerium oxide composition was prepared by the following method. In a closed, stirred container a one liter of a 0.12 M cerium (IV) ammonium nitrate solution was prepared from cerium (IV) ammonium nitrate crystals dissolved in nitric acid. To this was added 199.5 g (0.5 mol) commercially available Al(NO₃)₃ and held at approximately 90° C. for about 24 hours. In a separate container 200 ml of a 3M ammonium hydroxide solution was prepared and held at room temperature. Subsequently the two solutions were combined and stirred for approximately one hour. The resultant precipitate was filtered using Buchner funnel equipped with filter paper. The solids were then thoroughly washed in the Buchner using deionized water. Following the washing/filtering step, the wet hydrate was calcined in a muffle furnace at approximately 450° C. for three hours to form an aluminum cerium (IV) oxide composition. This oxide was suspended in a Praseodymium nitrate solution containing Praseodymium carbonate. The Pr to aluminum cerium (IV) oxide ratio was varied to achieve a 4%, 8%, 12% or 20% loading of Pr oxide on the final product. The ingredients were mixed for 2 hours. The mixture was then heated in a furnace to 550° C. for 2 hours to obtain a mixed cerium aluminum praseodymium oxide. This could also be called a Pr doped cerium oxide.

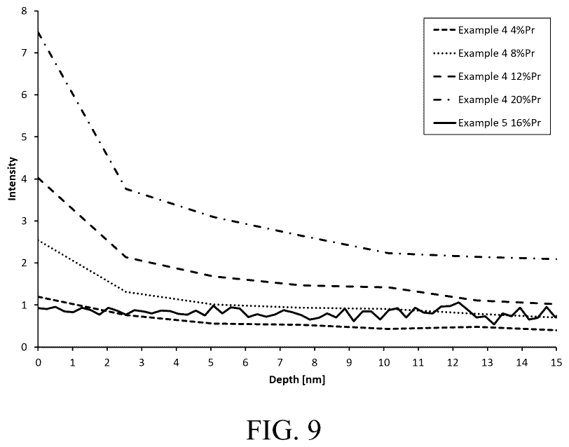

The depth profile of each of these materials was then measured and the PrO⁺ to ¹⁴⁰CeO⁺ ratio vs depth is presented in FIG. 9. As with Example 1 the trivalent, in this case PrO⁺, to ¹⁴⁰CeO⁺ ratio is higher at the surface and shallower depths and approaches a constant level as the depth increases. The Example 4 materials are embodiments of the trivalent doped cerium oxide having the unique depth profile.

### Example 5

A praseodymium doped cerium oxide composition was prepared by the following method. This method is similar to the method of Example 2. 129 ml of a 1 mol/L Ce(NO₃)₄ solution was mixed with 82 ml of a 1 mol/L Pr(NO₃)₃ solution and 63.9 g (0.3 mol) commercially available Al(NO₃)₃. The resulting solution was heated to reflux for at least 2 hours. 5.5 mol/L NH₄OH was then added to a pH of 10. The resulting solid was filtered and washed with DI water until the wash water was <15 mS/cm. The resulting powder was heated in a furnace in air at 550° C. for at least 2 hours to obtain a mixed cerium aluminum praseodymium oxide which contains approximately 16% Pr oxide by weight. This could also be called a Pr doped cerium oxide.

The depth profile was measured and the data is presented in FIG. 9. As in example 2 the trivalent, in this case PrO⁺, to ¹⁴⁰CeO⁺ ratio is nearly constant from the surface to the maximum depth measured. This indicates the concentration of Pr is nearly the same on the surface as it is at depth.

The depth profile data from examples 1, 2, 4 and 5 were then compared by averaging the trivalent to Ce ratio (LaO⁺/CeO⁺ or PrO⁺/CeO⁺) at depths of 0 to 3.5 nm. This average was then compared to the same ratio at a depth of 15 nm. The % increase was then calculated ((Average between 0 and 3.5 nm)−(ratio at 15 nm))/(ratio at 15 nm)×100.

TABLE 1
Comparison of average LaO⁺/CeO⁺ or PrO⁺/
CeO⁺ ratio from 0 to 3.5 nm vs ratio at 15 nm

| | Average ratio | Ratio at | % |
|---|---|---|---|
| Material | from 0 to 3.5 nm | 15 nm | increase |
| Example 1 | 0.3386 | 0.2548 | 32.9 |
| Example 2 | 0.2826 | 0.2638 | 7.15 |
| Example 4 @4% | 0.9793 | 0.3929 | 149 |
| Example 4 @8% | 1.9280 | 0.6920 | 178 |
| Example 4 @12% | 3.0797 | 1.0156 | 203 |
| Example 4 @20% | 5.6259 | 2.0905 | 169 |
| Example 5 | 0.0386 | 0.0529 | −27 |

### Example 6

A silver doped trivalent doped cerium oxide composition was prepared by the following method. 542 g of the La doped cerium oxide of example 1 was placed in a round flask on a rotary evaporator, rotated to mix, and heated to 60° C. 542 g of a silver nitrate solution containing 1% silver by weight was then added to the flask under reduced pressure. 3.10 g of a 50% citric acid solution was then add to the flask under reduced pressure. The slurry changed color to a metallic silver/grey. The rotation, heating, and reduced pressure was maintained until the material was a free-flowing powder. Further drying was done in an oven at 90° C. until the weight was constant (approximately 30 minutes).

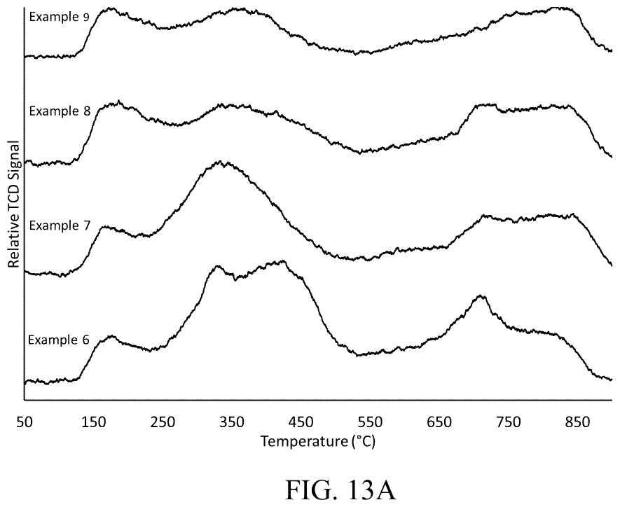

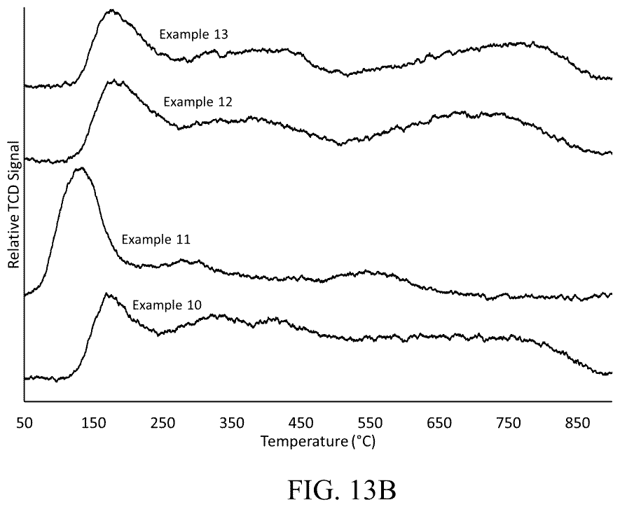

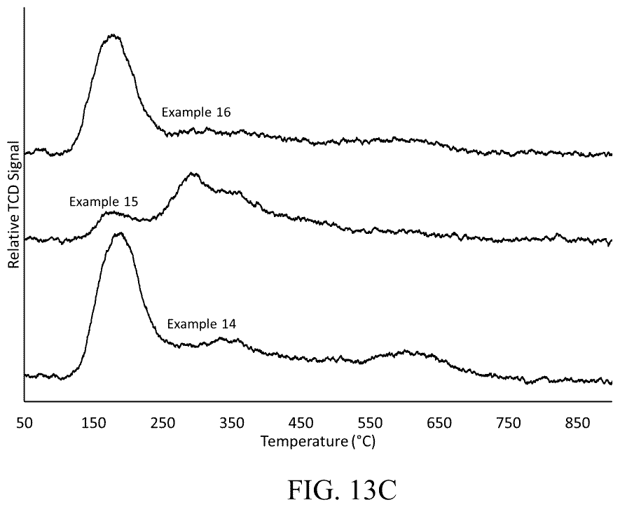

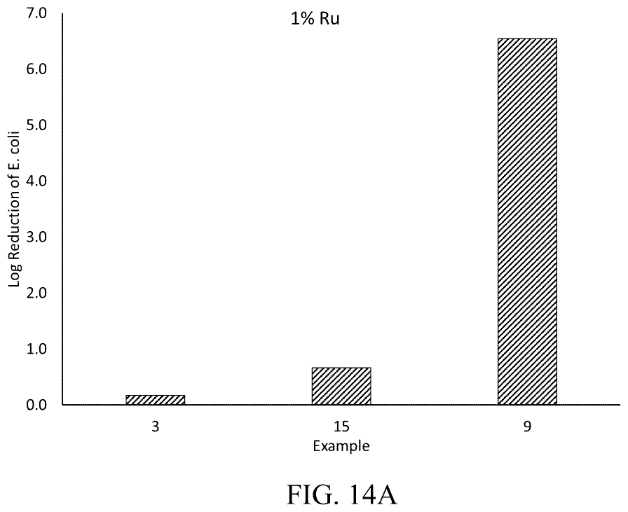

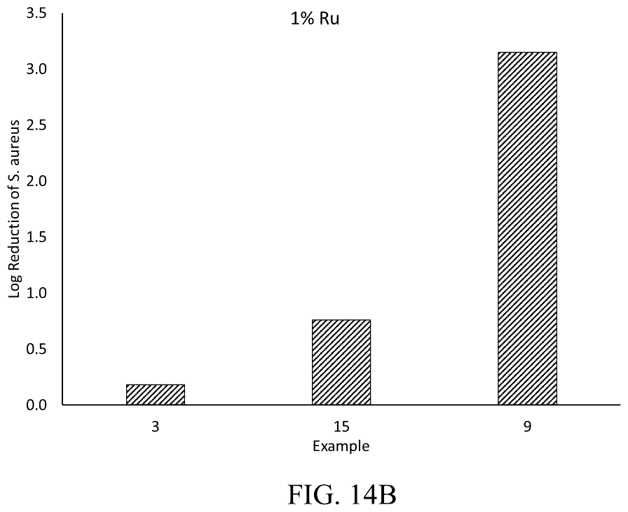

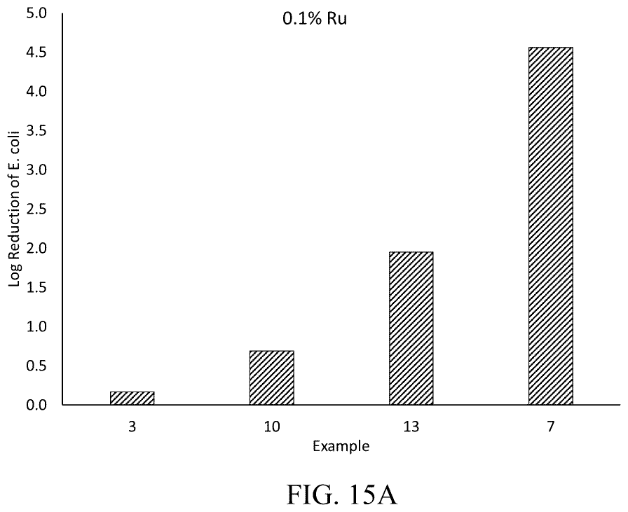

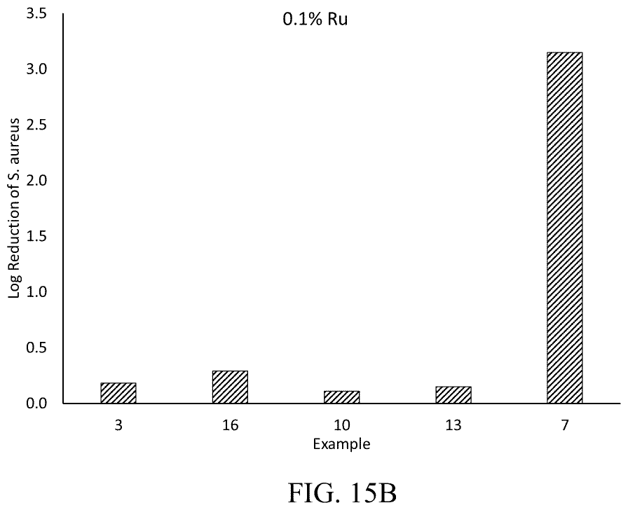

A sample of the example 6 composition was analyzed for surface area, pore radius, and pore volume and found to be 103.184 m²/g (BET) and 120.897 m²/g (BJH) with a pore radius of 2.992 nm and pore volume of 0.206 cc/g. The crystallite size as measured by XRD was determined to be 10.2 nm. The temperature programmed desorption profile is presented in FIG. 13A. The desorption of CO₂ had 3 peak temperatures 172° C., 350° C. and 735° C. indicating both physisorption and chemisorption of CO₂. The desorption of CO₂ resembles the desorption of CO₂ of example 1, thus the PGM dopant minimally affects the physical attributes of the material.

### Example 7

A silver and ruthenium doped trivalent doped cerium oxide composition was prepared by the following method. 542 g of the La doped cerium oxide of example 1 was placed in a round flask on a rotary evaporator, rotated to mix, and heated to 60° C. 542 g of a ruthenium(III) nitrosyl nitrate solution containing 0.09996% ruthenium by weight and 0.00004% silver by weight was then added to the flask under reduced pressure. 0.31 g of 50% citric acid solution was then add to the flask under reduced pressure. The slurry changed color to a metallic silver/grey. The rotation, heating, and reduced pressure was maintained until the material was a free-flowing powder. Further drying is done in an oven at 90° C. until the weight was constant (approximately 30 minutes).

A sample of the example 7 composition was analyzed for surface area, pore radius, and pore volume and found to be 104.323 m²/g (BET) and 127.824 m²/g (BJH) with a pore radius of 2.537 nm and pore volume of 0.232 cc/g. The crystallite size as measured by XRD was determined to be 10.5 nm. The temperature programmed desorption profile is presented in FIG. 13A. The desorption of CO₂ had 3 peak temperatures 172° C., 350° C. and 735° C. indicating both physisorption and chemisorption of CO₂. The desorption of CO₂ resembles the desorption of CO₂ of example 1, thus the PGM dopant minimally affects the physical attributes of the material.

### Example 8

A silver oxide doped trivalent doped cerium oxide composition was prepared by the following method. 542 g of the La doped cerium oxide of example 1 was placed in a round flask on a rotary evaporator, rotated to mix, and heated to 60° C. 542 g of a silver nitrate solution containing 0.1% silver by weight was then added to the flask under reduced pressure. The rotation, heating, and reduced pressure was maintained until the material was a free-flowing powder. The powder was further heated to 500° C. for 2 hours. The deposited silver was expected to be silver oxide.

A sample of the example 8 composition was analyzed for surface area, pore radius, and pore volume and found to be 89.964 m²/g (BET) and 138.397 m²/g (BJH) with a pore radius of 2.346 nm and pore volume of 0.299 cc/g. The crystallite size as measured by XRD was determined to be 11 nm. The temperature programmed desorption profile is presented in FIG. 13A. The desorption of CO₂ had 3 peak temperatures 172° C., 350° C. and 735° C. indicating both physisorption and chemisorption of CO₂. The desorption of CO₂ resembles the desorption of CO₂ of example 1, thus the PGM dopant minimally affects the physical attributes of the material.

### Example 9

A ruthenium oxide doped trivalent doped cerium oxide composition is prepared by the following method. 542 g of the La doped cerium oxide of example 1 was placed in a round flask on a rotary evaporator, rotated to mix, and heated to 60° C. 542 g of a ruthenium(III) nitrosyl nitrate solution containing 1% ruthenium by weight was then added to the flask under reduced pressure. The rotation, heating, and reduced pressure was maintained until the material was a free-flowing powder. The powder was further heated to 500° C. for 2 hours. The deposited ruthenium was expected to be ruthenium oxide.

A sample of the example 9 composition was analyzed for surface area, pore radius, and pore volume and found to be 98.745 m²/g (BET) and 126.338 m²/g (BJH) with a pore radius of 2.536 nm and pore volume of 0.214 cc/g. The crystallite size as measured by XRD was determined to be 10.6 nm. The temperature programmed desorption profile is presented in FIG. 13A. The desorption of CO₂ had 3 peak temperatures 172° C., 350° C. and 735° C. indicating both physisorption and chemisorption of CO₂. The desorption of CO₂ resembles the desorption of CO₂ of example 1, thus the PGM dopant minimally affects the physical attributes of the material.

### Example 10

A ruthenium doped trivalent doped cerium oxide composition was prepared by the following method. 542 g of the La doped cerium oxide of example 2 was placed in a round flask on a rotary evaporator, rotated to mix, and heated to 60° C. 542 g of a ruthenium(III) nitrosyl nitrate solution containing 0.1% ruthenium by weight was then added to the flask under reduced pressure. 0.310 g of a 50% citric acid by weight solution was then added to the flask under reduced pressure. The slurry changed color to a metallic silver/grey. The rotation, heating, and reduced pressure was maintained until the material was a free-flowing powder. Further drying was done in an oven at 90° C. until the weight was constant (approximately 30 minutes).

A sample of the example 10 composition was analyzed for surface area, pore radius, and pore volume and found to be 131.926 m²/g (BET) and 167.993 m²/g (BJH) with a pore radius of 2.988 nm and pore volume of 0.338 cc/g. The crystallite size as measured by XRD was determined to be 7.7 nm. The temperature programmed desorption profile is presented in FIG. 13B. The desorption of CO₂ had 1 peak temperature at 175° C. indicating only physisorption of CO₂. The desorption of CO₂ resembles the desorption of CO₂ of example 2, thus the PGM dopant minimally affects the physical attributes of the material.

### Example 11

A silver ruthenium doped trivalent doped cerium oxide composition was prepared by the following method. 542 g of the La doped cerium oxide of example 2 was placed in a round flask on a rotary evaporator, rotated to mix, and heated to 60° C. 542 g of a silver nitrate and ruthenium(III) nitrosyl nitrate solution containing 0.5% silver by weight and 0.5% ruthenium by weight is then added to the flask under reduced pressure. 4 g hydrazine hydrate is then added to the flask under reduced pressure. The slurry changed color to a metallic silver/grey. The rotation, heating, and reduced pressure was maintained until the material was a free-flowing powder. Further drying was done in an oven at 90° C. until the weight was constant (approximately 30 minutes).

A sample of the example 11 composition was analyzed for surface area, pore radius, and pore volume and found to be 105.810 m²/g (BET) and 127.365 m²/g (BJH) with a pore radius of 2.744 nm and pore volume of 0.212 cc/g. The crystallite size as measured by XRD was determined to be 10.5 nm. The temperature programmed desorption profile is presented in FIG. 13B. The desorption of CO₂ had 1 peak temperature at 175° C. indicating only physisorption of CO₂. The desorption of CO₂ resembles the desorption of CO₂ of example 2, thus the PGM dopant minimally affects the physical attributes of the material.

### Example 12

A silver oxide doped trivalent doped cerium oxide composition was prepared by the following method. 542 g of the La doped cerium oxide of example 2 was placed in a round flask on a rotary evaporator, rotated to mix, and heated to 60° C. 542 g of a silver nitrate solution containing 1% silver by weight was then added to the flask under reduced pressure. The rotation, heating, and reduced pressure was maintained until the material was a free-flowing powder. The powder was further heated to 500° C. for 2 hours. The deposited silver was expected to be a mixed silver oxide.

A sample of the example 12 composition was analyzed for surface area, pore radius, and pore volume and found to be 125.703 m²/g (BET) and 157.473 m²/g (BJH) with a pore radius of 2.988 nm and pore volume of 0.293 cc/g. The crystallite size as measured by XRD was determined to be 7.8 nm. The temperature programmed desorption profile is presented in FIG. 13B. The desorption of CO₂ had 1 peak temperature at 175° C. indicating only physisorption of CO₂. The desorption of CO₂ resembles the desorption of CO₂ of example 2, thus the PGM dopant minimally affects the physical attributes of the material.

### Example 13

A ruthenium oxide doped trivalent doped cerium oxide composition was prepared by the following method. 542 g of the La doped cerium oxide of example 2 was placed in a round flask on a rotary evaporator, rotated to mix, and heated to 60° C. 542 g of a ruthenium(III) nitrosyl nitrate solution containing 0.1% ruthenium by weight was then added to the flask under reduced pressure. The rotation, heating, and reduced pressure was maintained until the material was a free-flowing powder. The powder was further heated to 500° C. for 2 hours. The deposited ruthenium was expected to be ruthenium oxide.

A sample of the example 13 composition was analyzed for surface area, pore radius, and pore volume and found to be 130.804 m²/g (BET) and 165.211 m²/g (BJH) with a pore radius of 2.999 nm and pore volume of 0.307 cc/g. The crystallite size as measured by XRD was determined to be 7.7 nm. The temperature programmed desorption profile is presented in FIG. 13B. The desorption of CO₂ had 1 peak temperature at 175° C. indicating only physisorption of CO₂. The desorption of CO₂ resembles the desorption of CO₂ of example 2, thus the PGM dopant minimally affects the physical attributes of the material.

### Example 14

A silver doped cerium (IV) oxide composition was prepared by the following method. 542 g of the cerium (IV) oxide composition of example 3 was placed in a round flask on a rotary evaporator, rotated to mix, and heated to 60° C. 542 g of a silver nitrate solution containing 0.1% silver by weight was then added to the flask under reduced pressure. 0.310 g of a 50% citric acid solution was then added to the flask under reduced pressure. The slurry changes color to a metallic silver/grey. The rotation, heating, and reduced pressure was maintained until the material was a free-flowing powder. Further drying was done in an oven at 90° C. until the weight was constant (approximately 30 minutes).

A sample of the example 14 composition was analyzed for surface area, pore radius, and pore volume and found to be 151.333 m²/g (BET) and 198.860 m²/g (BJH) with a pore radius of 1.892 nm and pore volume of 0.207 cc/g. The crystallite size as measured by XRD was determined to be 8.5 nm. The temperature programmed desorption profile is presented in FIG. 13C. The desorption of CO₂ had 1 peak temperature at 175° C. indicating only physisorption of CO₂. The desorption of CO₂ resembles the desorption of CO₂ of example 3, thus the PGM dopant minimally affects the physical attributes of the material.

### Example 15

A ruthenium doped cerium (IV) oxide composition was prepared by the following method. 542 g of the cerium (IV) oxide composition of example 3 was placed in a round flask on a rotary evaporator, rotated to mix, and heated to 60° C. 542 g of a ruthenium(III) nitrosyl nitrate solution containing 1% ruthenium by weight was then added to the flask under reduced pressure. 4 g of hydrazine hydrate was then added to the flask under reduced pressure. The slurry changed color to a metallic silver/grey. The rotation, heating, and reduced pressure was maintained until the material was a free-flowing powder. Further drying was done in an oven at 90° C. until the weight was constant (approximately 30 minutes).

A sample of the example 15 composition was analyzed for surface area, pore radius, and pore volume and found to be 150.679 m²/g (BET) and 189.460 m²/g (BJH) with a pore radius of 1.769 nm and pore volume of 0.192 cc/g. The crystallite size as measured by XRD was determined to be 8.3 nm. The temperature programmed desorption profile is presented in FIG. 13C. The desorption of CO₂ had 1 peak temperature at 175° C. indicating only physisorption of CO₂. The desorption of CO₂ resembles the desorption of CO₂ of example 3, thus the PGM dopant minimally affects the physical attributes of the material.

### Example 16

A ruthenium oxide doped cerium (IV) oxide composition is prepared by the following method. 542 g of the cerium (IV) oxide composition of example 3 was placed in a round flask on a rotary evaporator, rotated to mix, and heated to 60° C. 542 g of a ruthenium(III) nitrosyl nitrate solution containing 0.1% ruthenium by weight was then added to the flask under reduced pressure. The rotation, heating, and reduced pressure was maintained until the material was a free-flowing powder. The powder was further heated to 500° C. for 2 hours. The deposited ruthenium was expected to be ruthenium oxide.

A sample of the example 16 composition was analyzed for surface area, pore radius, and pore volume and found to be 144.278 m²/g (BET) and 187.392 m²/g (BJH) with a pore radius of 1.891 nm and pore volume of 0.199 cc/g. The crystallite size as measured by XRD was determined to be 8.5 nm. The temperature programmed desorption profile is presented in FIG. 13C. The desorption of CO₂ had 1 peak temperature at 175° C. indicating only physisorption of CO₂. The desorption of CO₂ resembles the desorption of CO₂ of example 3, thus the PGM dopant minimally affects the physical attributes of the material.

### Example 17

Bacterial Removal Characteristics of the compositions of Example 3 and Examples 6 through 16 were tested using the ASTM International Method E2149. Test materials in the amount of 1.0±0.1 g were added to 50 ml suspensions ofeither Staphylococcus aureus ATCC 6538 or Escherichia coli ATCC 8739 prepared by diluting suspensions of the microorganisms, which were initiated in tryptic soy broth and allowed to incubate under conditions necessary for sufficient growth prior to testing, to a target concentration of approximately 2×10⁵ CFU/ml (Colony Forming Units). Inoculated suspensions were secured on a wrist action shaker and incubated dynamically for 30 minutes. Aliquots of the test and control suspensions were harvested and enumerated and plated using standard dilution and plating techniques. The plates were incubated for 18-24 hours at incubation conditions optimal for the target test microorganism(s).

TABLE 2
Antimicrobial results for examples 6-16

| | E. coli | | | S. aureus | | |
|---|---|---|---|---|---|---|
| | Average | % | Log | Average | % | Log |
| Example | CFU/ml | Reduction | Reduction | CFU/ml | Reduction | Reduction |
| Control | 3.5 × 10⁶ | — | — | 2.63 × 10⁶ | — | — |
| 3 | 2.37 × 10⁶ | 32.3810% | 0.17 | 2.32 × 10⁶ | 33.8095% | 0.18 |
| 6 | BDL | >99.9999% | >6.54 | BDL | >99.9999% | >6.42 |
| 7 | 9.67 × 10¹ | 99.9972% | 4.56 | 2.5 × 10³ | 99.9286% | 3.15 |
| 8 | BDL | >99.9999% | >6.54 | BDL | >99.9999% | >6.42 |
| 9 | BDL | >99.9999% | >6.54 | 2.5 × 10³ | 99.9286% | 3.15 |
| 10 | 7.13 × 10⁵ | 79.6190% | 0.69 | 2.69 × 10⁶ | 23.1429% | 0.11 |
| 11 | BDL | >99.9999% | >6.54 | 1.5 × 10¹ | 99.9996% | 5.37 |
| 12 | BDL | >99.9999% | >6.54 | BDL | >99.9999% | >6.42 |
| 13 | 3.97 × 10⁴ | 98.8667% | 1.95 | 2.5 × 10⁶ | 28.5714% | 0.15 |
| 14 | BDL | NM | NM | 4.47 × 10² | 99.9872% | 3.89 |
| 15 | 7.70 × 10⁵ | 78.0000% | 0.66 | 6.07 × 10⁵ | 82.6667% | 0.76 |
| 16 | BDL | NM | NM | 1.81 × 10⁶ | 48.1905% | 0.29 |

BDL-Below Detection Limit, NM-Not Measured

TABLE 3
Antimicrobial results with 1% PGM

| | Particulate | | E. coli | S. aureus |
|---|---|---|---|---|
| Example | oxide | PGM dopant | Log reduction | Log reduction |
| 3 | | 0% | 0.17 | 0.18 |
| 15 | 3 | 1% Ru | 0.66 | 0.76 |
| 9 | 1 | 1% Ru | >6.54 | 3.15 |
| 11 | 2 | 0.5% Ru, | >6.54 | 5.37 |
| | | 0.5% Ag | | |
| 12 | 2 | 1% Ag | >6.54 | >6.42 |
| 6 | 1 | 1% Ag | >6.54 | >6.42 |

The results summarized in Table 3 were the Log removal of either E. coli or S. aureus when exposed to the particulate oxides with 1% PGM dispersed on the surface. The cerium oxide of example 3 was included as a comparison and showed poor antimicrobial performance. Placing 1% Ru on the cerium oxide of example 3 (material of example 15) increased the antimicrobial performance slightly. The material of example 1 with 1% Ru (material of example 9) showed a striking increase in antimicrobial performance. The material of example 2 with 1% PGM split 50/50 Ru/Ag (material of example 11) showed increased antimicrobial performance but a significant portion of that could be due to the presence of Ag. The materials with a 1% Ag loading (materials of examples 12 and 6) were very active regardless of whether the material of example 1 or 2 were doped with Ag. Thus, Ag showed high antimicrobial performance and 1% Ag was too active to distinguish the materials of example 1 and 2 doped with Ag.

TABLE 4
Antimicrobial results with 0.1% PGM

| | Particulate | | E. coli | S. aureus |
|---|---|---|---|---|
| Example | oxide | PGM dopant | Log reduction | Log reduction |
| 3 | | 0% | 0.17 | 0.18 |
| 16 | 3 | 0.1% Ru | Not measured | 0.29 |
| 10 | 2 | 0.1% Ru | 0.69 | 0.11 |
| 13 | 2 | 0.1% Ru | 1.95 | 0.15 |
| 7 | 1 | 0.09996% Ru, | 4.56 | 3.15 |
| | | 0.00004% Ag | | |
| 14 | 3 | 0.1% Ag | Not measured | 3.89 |
| 8 | 1 | 0.1% Ag | >6.54 | >6.42 |

The results summarized in Table 4 were the Log removal of either E. coli or S. aureus when exposed to the particulate oxides with 0.1% PGM dispersed on the surface. The cerium oxide of example 3 was included as a comparison and showed poor antimicrobial performance. Placing 0.1% Ru on the cerium oxide of example 3 (material of example 16) did not increase the antimicrobial performance significantly. A slight increase in antimicrobial performance was observed when the material of example 2 with 0.1% Ru (material of example 10) was used and a significant increase when the material of example 1 with 0.09996% Ru and 0.00004% Ag (material of example 7, total PGM 0.1%) was used. These results also showed that a 0.1% Ag doping is quite active. 0.1% Ag on the material of example 1 (material of example 8) showed an increased antimicrobial performance over 0.1% Ag on the material of example 3 (material of example 14). Thus, the PGM dopant alone was not solely responsible for the observed antimicrobial activity. One would expect a 0.1% PGM loading to have a lower performance than a 1% loading and that was consistent with these results. However, the differences between the particulate oxide materials of examples 1, 2, and 3 with similar PGM doping was not expected. The PGM doped example 1 materials showed increased antimicrobial performance versus the similarly PGM doped materials of examples 2 or 3.

### Example 19

The material of example 7 is suspended in deionized water and a binder, such as citric acid, is added to the water. A substrate, such as cotton fabric, is then immersed in the suspension at least one time. After removing the substrate, it is allowed to dry. The resulting fabric has a coating of the composition of example 1 its surface. This coated fabric is then placed on an air filter such that fabric covers the face of the air filter and air can pass though the fabric. The filter is then placed in an HVAC or room air filtration unit. Upon turning on the unit, air contaminated with coronavirus is passed through the filter. The air discharged from the unit is analyzed and found to have a reduced concentration of coronavirus.

### Example 20

Polyethylene granules or powder is mechanically mixed with the material of example 7 such that the material of example 7 is approximately 1% by weight. The mixture is then fed into a heating chamber to form an end use product such as a bottle. After the bottle is formed from the polyethylene containing material from example 7, the surface to the polyethylene is tested for antibacterial or bacteriostatic properties by exposing the surface to E. coli. The surface is then analyzed for E. coli and found to have less colony forming units than a control. Another test is conducted by putting pasteurized milk in the formed bottle and observing the time necessary for the milk to spoil. Compared a polyethylene bottle without the material of example 1, the milk takes a longer time to spoil.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

What is claimed is:

1. An antimicrobial composition comprising:
(a) about 99.95 wt % to about 50 wt % of a particulate oxide composition comprising:
cerium oxide;
trivalent dopant selected from the group consisting of yttrium (Y), lanthanum (La), neodymium (Nd), praseodymium (Pr), and mixtures thereof; and
optionally an additional oxide selected from the group consisting of aluminum (Al), titanium (Ti), zirconium (Zr), hafnium (Hf), silicon (Si) and mixtures thereof,
wherein the cerium oxide being present in an amount greater than the trivalent dopant and wherein the average trivalent dopant to Ce ratio at about 0 nm to about 3.5 nm from the surface of the particulate oxide composition is greater than the trivalent dopant to Ce ratio at about 15 nm from the surface of the particulate composition; and
(b) precious metals dispersed on the surface of the particulate oxide composition, wherein the precious metals are selected from the group consisting of copper (Cu), nickel (Ni), silver (Ag), palladium (Pd), platinum (Pt), ruthenium (Ru), gold (Au), osmium (Os), rhodium (Rh), and mixtures thereof.

2. The antimicrobial composition of claim 1 comprising the precious metals in an amount of about 0.05 wt % to 25 wt % based on the total weight of the antimicrobial composition.

3. The antimicrobial composition of claim 2 comprising the precious metals in an amount of about 0.05 wt % to about 10 wt % based on the total weight of the antimicrobial composition.

4. The antimicrobial composition of claim 3 comprising the precious metals in an amount of about 0.05 wt % to about 8 wt % based on the total weight of the antimicrobial composition.

5. The antimicrobial composition of claim 2, wherein the precious metals are silver (Ag), palladium (Pd), platinum (Pt), ruthenium (Ru), or mixtures thereof.

6. The antimicrobial composition of claim 5, wherein the precious metals are silver (Ag), ruthenium (Ru), or mixtures thereof.

7. The antimicrobial composition of claim 6, wherein the precious metals are silver (Ag) and are in an amount of about 0.05 wt % to about 0.3 wt % based on the total weight of the antimicrobial composition.

8. The antimicrobial composition of claim 6, wherein the precious metals are ruthenium (Ru) and are in an amount of about 0.05 wt % to about 5 wt % based on the total weight of the antimicrobial composition.

9. The antimicrobial composition of claim 2, wherein the precious metals are dispersed on the surface of the particulate oxide composition as metallic or as oxides.

10. The antimicrobial composition of claim 1, wherein the particulate oxide composition comprises:
cerium oxide in an amount of about 99.9 wt % to about 20 wt % based on the total weight of the particulate oxide composition;
trivalent dopant in an amount of about 0.1 wt % up to about 50 wt % based on the total weight of the particulate oxide composition; and
additional oxide in an amount of about 70 wt % to about 0 wt % based on the total weight of the particulate oxide composition.

11. The antimicrobial composition of claim 1, wherein the particulate oxide composition comprises:
cerium oxide in an amount of about 20 wt % to about 30 wt % based on the total weight of the particulate oxide composition;
trivalent dopant in an amount of about 2 wt % to about 25 wt % based on the total weight of the particulate oxide composition; and
additional oxide in an amount of about 45 wt % to about 78 wt % based on the total weight of the particulate oxide composition.

12. The antimicrobial composition of claim 1, wherein the particulate oxide composition comprises:
cerium oxide in an amount of about 45 wt % to about 78 wt % based on the total weight of the particulate oxide composition;
trivalent dopant in an amount of about 2 wt % to about 25 wt % based on the total weight of the particulate oxide composition; and
additional metal oxide in an amount of about 20 wt % to about 30 wt % based on the total weight of the particulate oxide composition.

13. The antimicrobial composition of claim 2, wherein in the particulate oxide composition the average trivalent dopant to Ce ratio at about 0 nm to about 3.5 nm from the surface of the particulate composition is about 10% to about 250% greater than the trivalent dopant to Ce ratio at about 15 nm from the surface of the particulate oxide composition.

14. The antimicrobial composition of claim 1 comprising the precious metals in an amount of about 0.05 wt % to about 10 wt % based on the total weight of the antimicrobial composition and the particulate oxide composition comprises about 2 wt % to about 30 wt % trivalent dopant.

15. A supported composition for removing biological contaminants comprising:
a support material comprising an organic polymer, cotton, glass fiber, or mixtures thereof; and the antimicrobial composition of claim 1,
wherein the antimicrobial composition is deposited on or within the support material.

16. The supported composition of claim 15, wherein the support material is an organic polymer selected from the group consisting of polyethylene, polyvinyl chloride, nylon, polypropylene, polyester, polyurethane, polyamide, polyolefin, polycarbonate, copolymers thereof, and mixtures thereof.

17. The supported composition of claim 15, wherein the support material is cotton.

18. The supported composition of claim 15, wherein the supported composition comprises about 0.5 to about 80 weight % of the antimicrobial composition based on the total weight of the supported composition.

19. The supported composition of claim 15, wherein the supported composition is a filter material or a plastic.

20. A method for removing biological contaminants comprising:
providing the antimicrobial composition of claim 1;
contacting the composition with a biological contaminant wherein the biological contaminant is selected from the group consisting of bacteria, viruses, protozoa, fungi, and mixtures thereof; and
removing at least about 90% of the biological contaminant through contact with the composition.

21. The method of claim 20, wherein the antimicrobial composition is contained within a filter material or a plastic.

22. The method of claim 20, wherein the antimicrobial composition is deposited on or within a support material comprising an organic polymer, cotton, glass fiber, or mixtures thereof.

23. The method of claim 20, wherein the biological contaminant is in an aqueous stream or a gaseous stream, or a mixture thereof.

24. The method of claim 20, wherein the contacting is through touch of a solid to an article comprising the antimicrobial composition.

25. The method of claim 20, further comprising the steps of setting a target concentration of biological contaminant and monitoring after contacting for the biological contaminant.

26. A plastic article comprising:
(a) a supported composition for removing biological contaminants comprising: an organic polymer selected from the group consisting of polyethylene, polyvinyl chloride, nylon, polypropylene, polyester, polyurethane, polyamide, polyolefin, polycarbonate, copolymers thereof, and mixtures thereof; and the antimicrobial composition of claim 1, wherein in the supported composition, the antimicrobial composition is deposited on or within the organic polymer; and
wherein the plastic article comprises about 50 to about 100 weight percent of the supported composition for removing biological contaminants based on the total weight of the plastic article.
